(19) United States
(12) Patent Application Publication
(10) Pub. No.: US 2008/0232865 A1
(43) Pub. Date: Sep. 25, 2008

(54) MAGNET ROLLER, DEVELOPING AGENT CARRIER, DEVELOPING UNIT, PROCESS CARTRIDGE AND IMAGE FORMING APPARATUS USING SAME

(76) Inventors: Mieko TERASHIMA, Isehara city (JP); Tsuyoshi Imamura, Sagamihara city (JP); Kyohta Koetsuka, Fujisawa city (JP); Yoshiyuki Takano, Hachioji city (JP); Noriyuki Kamiya, Yamato city (JP); Masayuki Ohsawa, Atsugi city (JP); Hiroya Abe, Yokohama city (JP); Takashi Innami, Atsugi city (JP); Tadaaki Hattori, Hadano city (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/050,547

(22) Filed: Mar. 18, 2008

(30) Foreign Application Priority Data
Mar. 19, 2007 (JP) 2007-070791

(51) Int. Cl. G03G 15/09; H01F 7/02

(52) U.S. Cl. 399/286; 492/8

(57) ABSTRACT

A magnet roller for use with a hollow cylindrical structure made of a non-magnetic material includes a roller body and a reinforcing member. The roller body, encased in the hollow cylindrical structure, has at least one magnetic pole to form an agent releasing area on a skin of the cylindrical structure. The roller body is integrated with a shaft on each end portion of the roller body as one solid body. The reinforcing member is embedded in a portion of the roller body corresponding to the agent releasing area. The reinforcing member is made of a material different from a material used for the roller body and extends in an axial direction of the roller body.

### CROSS-REFERENCE TO RELATED APPLICATIONS

This application claims priority from Japanese Patent Application No. 2007-070791, filed on Mar. 19, 2007 in the Japan Patent Office, the entire contents of which are hereby incorporated by reference herein.

### BACKGROUND OF THE INVENTION

1. Field of the Invention

The present disclosure generally relates to a magnet roller, a developing agent carrier, a developing unit, a process cartridge, and an image forming apparatus having the magnet roller.

2. Description of the Background Art

Generally, an image forming apparatus using electrophotography, such as, a copier, a printer, or a facsimile, includes a photoconductor as an image carrier. The photoconductor has a photosensitive layer charged by a charge roller, and an optical writing unit irradiates the charged photosensitive layer with a laser beam to form a latent image. After developing the latent image as a toner image, the toner image is transferred onto a transfer member such as, a sheet.

Such image forming apparatuses include a developing unit that uses a development process in which a two-component developing agent consisting of a non-magnetic toner and a magnetic carrier mixed together is used. Such a developing unit includes a developing agent carrier configured with a developing sleeve, made of non-magnetic cylindrical body, and a magnet roller disposed in the developing sleeve.

The magnet roller includes a plurality of magnetic poles disposed in a circumferential direction of the magnet roller. Using the magnetic force exerted by the plurality of magnetic poles, the developing agent can form chains projected from a skin of the developing sleeve. The developing agent carrier transports the developing agent to a development area facing a photoconductor and a latent image formed on the photoconductor is developed by the developing agent as a toner image. The magnetic carrier of the developing agent forms chains on a surface of the developing sleeve along magnetic force lines generated by the magnet roller, and toner is attracted to the chained magnetic carrier.

Recently, there has emerged a market demand for an image forming apparatus with a better color image forming capability and a more compact size. Because an image forming apparatus generally needs four developing units to form full color images, such developing units may need to be compact in size to reduce a size of the image forming apparatus. To reduce the size of the developing unit, the developing agent carrier particles need to be compact in size. For example, the developing agent carrier particles may need to have a reduced diameter.

To reduce the size of the developing agent carrier, a developing sleeve and a magnet roller disposed in the developing sleeve may need to be compact in size. For example, the developing sleeve and the magnet roller may need a reduced diameter. However, if the magnet roller has a reduced diameter, the magnet roller has a smaller volume size, by which the magnet roller generates a weaker magnetic force, thus weakening the magnetic force for accumulating developing agent on a surface of the developing sleeve. If the magnetic force on the developing sleeve weakens, a sufficient amount of developing agent may not be transported to the development area.

One related-art technique uses a magnet roller having pseudo multiple magnetic poles. However, a developing agent carrier using such magnet roller may not exert a sufficient magnetic force on an external surface of the developing agent carrier. Consequently, a sufficient intensity is not obtained for magnetic force, by which a sufficient amount of developing agent cannot be transported to the development area, and moreover a metallic mold for forming such magnet roller acquires a complex structure.

Another technique involves a magnet roller having a roller body made of isotropic ferrite plastic magnet and a magnet block attached to a part of the roller body. However, such magnet roller may not have an enough magnetic flux density for magnetic poles other than a development pole, which is not preferably used for a developing unit using two-component developing agent. Accordingly, such magnet roller may not be preferable for an image forming apparatus for forming color image.

Yet another technique involves a magnet roller having a roller body, formed in a pipe shape by extrusion molding and with a core metal inserted therein, and a rare earth magnet embedded to the roller body. However, such magnet roller may not have a sufficient volume size as the roller body if an outer diameter is set smaller for the magnet roller. Accordingly, such magnet roller may not generate a greater magnetic force.

In order to manufacture a magnet roller having sufficient magnetic force and yet is also compact in size, an entire magnet roller may be manufactured out of a single solid piece of magnetic material instead of inserting a core metal such as, iron or stainless steel, in the magnet material. However, such magnet roller may not have sufficient stiffness (rigidity), which can result in lack of a requisite precision in alignment of the magnet roller and the developing sleeve. Accordingly, such an image forming apparatus cannot produce images with higher precision. Further, the magnet roller may deform, and in a worst case cause a break failure.

### SUMMARY

The present disclosure relates to a magnet roller for use with a hollow cylindrical structure made of a non-magnetic material. The magnet roller includes a roller body and a reinforcing member. The roller body, encased in the hollow cylindrical structure, has at least one magnetic pole to form an agent releasing area on a skin of the cylindrical structure. The roller body is integrated with a shaft on each end portion of the roller body as one solid body. The reinforcing member is embedded in a portion of the roller body corresponding to the agent releasing area. The reinforcing member is made of a material different from a material used for the roller body and extends in an axial direction of the roller body.

The present disclosure also relates to an image forming apparatus having a developing sleeve and a magnet roller. The developing sleeve having a hollow cylindrical structure is made of a non-magnetic material. The magnet roller includes a roller body and a reinforcing member. The roller body, encased in the hollow cylindrical structure, has at least one magnetic pole to form an agent releasing area on a skin of the cylindrical structure. The roller body is integrated with a shaft on each end portion of the roller body as one solid body. The reinforcing member is embedded in a portion of the roller body corresponding to the agent releasing area. The reinforcing member is made of a material different from a material used for the roller body and extends in an axial direction of the roller body.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a cross-sectional view of an image forming apparatus having a process cartridge according to an exemplary embodiment;

FIG. 2 illustrates a cross-sectional view of the process cartridge having a developing unit, used in the image forming apparatus of FIG. 1;

FIG. 3 illustrates a cross-sectional view of the developing unit having a developing roller, used in the process cartridge of FIG. 2;

FIG. 4 illustrates a perspective view of a magnet roller used in the developing roller of FIG. 3;

FIG. 5 illustrates a cross-sectional view of the developing roller of FIG. 3 having magnetic poles;

FIG. 6 illustrates a cross-sectional view of the magnet roller used in the developing roller of FIG. 5;

FIG. 7 illustrates a perspective view of a developing sleeve of the developing roller of FIG. 3;

FIG. 8 is an expanded surface-pictured view of a skin of the developing sleeve of FIG. 7;

FIG. 9 illustrates a schematic view of a skin of the developing sleeve of FIG. 8;

FIG. 10 illustrates a schematic configuration of metallic molds for forming the magnet roller of FIG. 3;

FIG. 11A illustrates a process for forming a roller body of a magnet roller in a magnetic field;

FIG. 11B illustrates a process for fixing a magnet block to the roller body formed by the process of FIG. 11A;

FIG. 11C illustrates a process for magnetizing a magnet roller having the magnet block;

FIG. 12 illustrates a perspective view of a surface treatment machine used for conducting surface roughening process to a skin of the developing sleeve of FIG. 7;

FIG. 13 illustrates a cross-sectional view of the surface treatment machine, taken along the line 2-2 of FIG. 12;

FIG. 14 illustrates a perspective view of a wire member used in the surface treatment machine of FIG. 12;

FIG. 15 illustrates a schematic cross-sectional view of a wire member and a developing sleeve to be treated in the surface treatment machine of FIG. 12, in which the wire member rotates about its center while rotatingly moves along an outer circumference of the developing sleeve; and

FIGS. 16 to 18 illustrate cross-sectional views of another developing rollers according to another exemplary embodiments.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing expanded view s shown in the drawings, specific terminology is employed for the sake of clarity, the present disclosure is not limited to the specific terminology so selected and it is to be understood that each specific element includes all technical equivalents that operate in a similar manner.

Referring now to the drawings, an image forming apparatus according to an exemplary embodiment is described with reference to accompanying drawings. The image forming apparatus may employ electrophotography, for example.

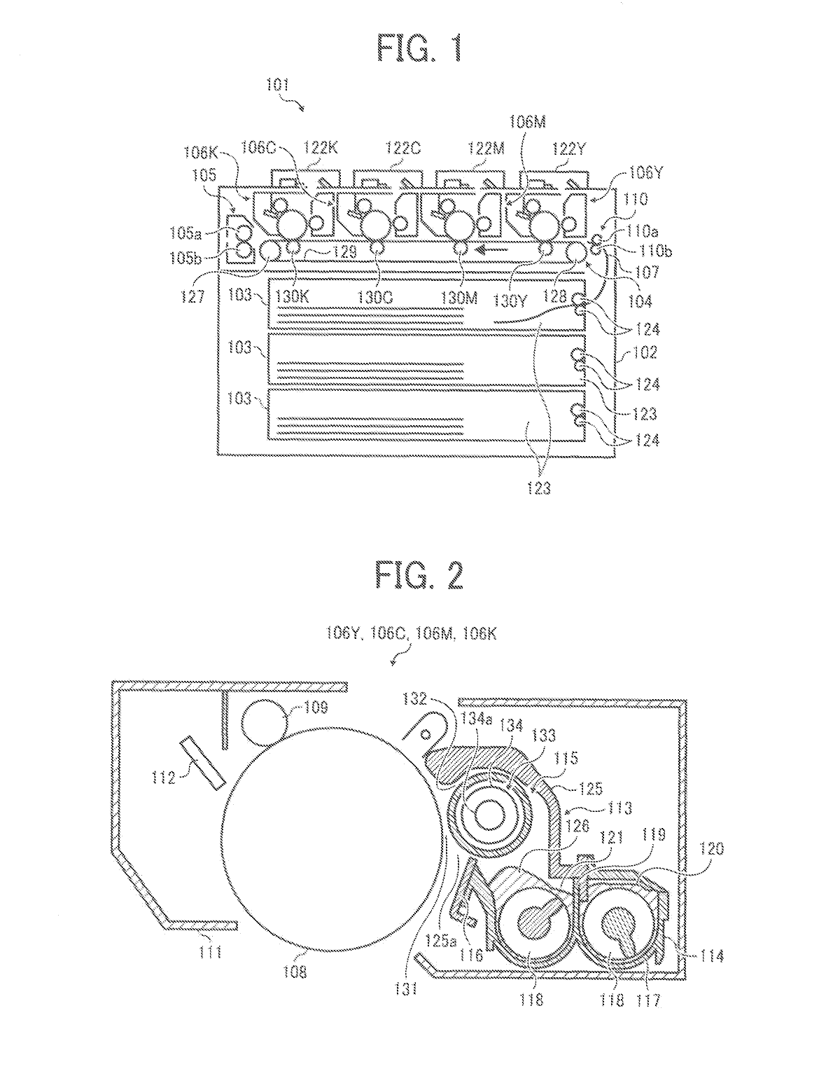

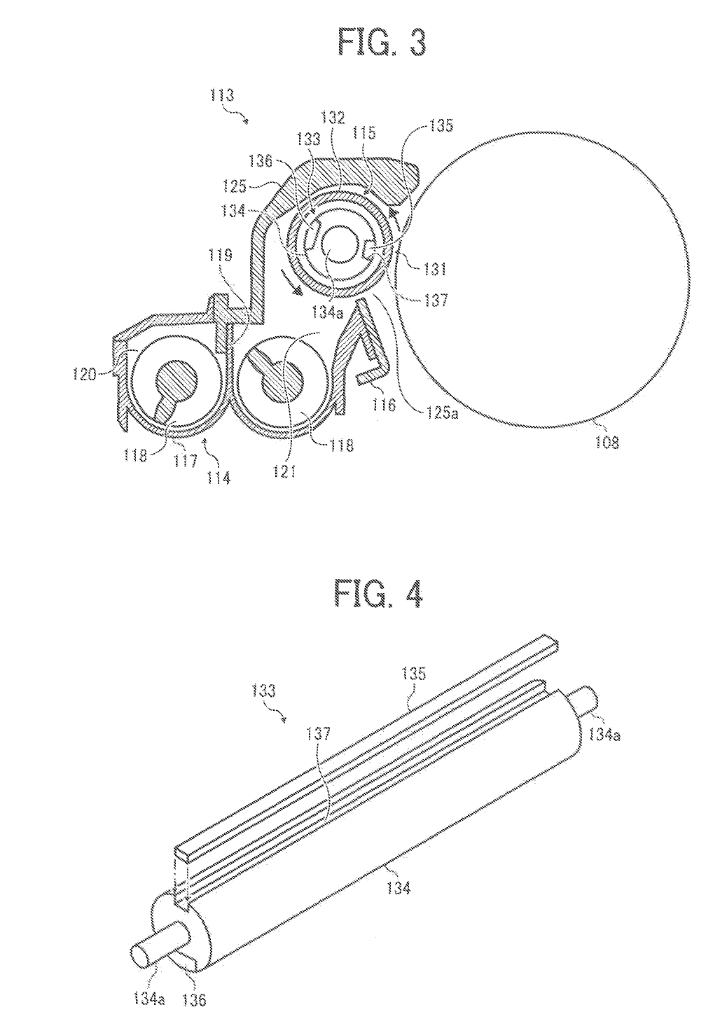

FIG. 1 illustrates a schematic configuration of an image forming apparatus according to an exemplary embodiment. FIG. 2 illustrates a cross-sectional view of a process cartridge used in the image forming apparatus of FIG. 1. FIG. 3 illustrates a cross-sectional view of a developing unit used in the process cartridge of FIG. 2. FIG. 4 is a perspective exploded view of a magnet roller of the developing unit of FIG. 3.

As illustrated in FIG. 1, an image forming apparatus 101 forms an color image having yellow (Y), magenta (M), cyan (C), and black (K) color on a recording medium 107 (e.g., sheet). Hereinafter, suffixes of Y, M, C, and K respectively indicate yellow, magenta, cyan, and black in this disclosure.

The image forming apparatus 101 includes a housing 102, a sheet feed unit 103, a registration roller 110, a transfer unit 104, a fusing unit 105, a plurality of the optical writing units 122Y, 122M, 122C, and 122K, and a plurality of process cartridges 106Y, 106M, 106C, and 106K, for example.

The housing 102, structured in a box shape, may be mounted on a floor, for example. The housing 102 houses the sheet feed unit 103, the registration roller 110, the transfer unit 104, the fusing unit 105, the plurality of the optical writing units 122Y, 122M, 122C, and 122K, and the plurality of the process cartridges 106Y, 106M, 106C, and 106K, for example.

The housing 102 may house a plurality of the sheet feed units 103 at its lower section. The sheet feed unit 103, storing a plurality of the recording medium 107, includes a sheet cassette 123 retractably mounted in the housing 102, and a feed roller 124. The feed roller 124 is pressed to a top sheet of the recording medium 107 in the sheet cassette 123. The feed roller 124 feeds the top sheet of the recording medium 107 to a position between a photosensitive drum 108 in a developing unit 113 of the process cartridges 106Y, 106M, 106C, and 106K and a transport belt 129 of the transfer unit 104, to be described later.

The registration roller 110 including rollers 110a and 110b is disposed at a given position along a transport route of the recording medium 107 transported from the sheet feed unit 103 to the transfer unit 104. The registration roller 110 stops a movement of the recording medium 107 for a given time using the rollers 110a and lob, and then feed the recording medium 107 to a space between the transfer unit 104 and the process cartridges 106Y, 106M, 106C, and 106K at a given timing so that toner images can be superimposed and transferred on the recording medium 107 correctly.

The transfer unit 104, provided over the sheet feed unit 103, includes a drive roller 127, a driven roller 128, a transport belt 129, and transfer rollers 130Y, 130M, 130C, 130K, for example. The drive roller 127 is rotated by a drive unit such as, motor, and the driven roller 128 is rotated when the transport belt 129 rotates in a given direction. The transport belt 129, made as endless belt, is extended by the drive roller 127 and the driven roller 128. With a rotation of the drive roller 127, the transport belt 129 rotates in a counter-clockwise direction, for example.

Each of the transfer rollers 130Y, 130M, 130C, and 130K sandwiches the transport belt 129 with the photosensitive drum 108 of the respective process cartridges 106Y, 106M, 106C, and 106K, wherein the transport belt 129 transports the recording medium 107. With an effect of the transfer rollers 130Y, 130M, 130C, and 130K, toner image on the photosensitive drum 108 is transferred to the recording medium 107, fed from the sheet feed unit 103. After transferring toner image, the transfer unit 104 feeds the recording medium 107 to the fusing unit 105.

The fusing unit 105 includes rollers 105a and 105b, in which the rollers 105a and 105b sandwiches the recording medium 107 therebetween. The rollers 105a and 105b apply heat and pressure to the recording medium 107 to fix the toner image on the recording medium 107.

The optical writing units 122Y, 122M, 122C, and 122K are respectively disposed for the process cartridges 106Y, 106M, 106C, and 106K at an upper portion of the housing 102. The optical writing units 122Y, 122M, 122C, and 122K irradiate respective laser beams to the photosensitive drum 108, uniformly charged by a charge roller 109, to form a latent image on the photosensitive drum 108.

The process cartridges 106Y, 106M, 106C, and 106K are respectively disposed between the transfer unit 104 and the optical writing units 122Y, 122M, 122C, and 122K. The process cartridges 106Y, 106M, 106C, and 106K are detachably mountable in the housing 102. The process cartridges 106Y, 106M, 106C, and 106K may be arranged one another in a direction of transporting the recording medium 107, for example.

As illustrated in FIG. 2, each of the process cartridges 106Y, 106M, 106C, and 106K includes a casing 111, the charge roller 109, the photosensitive drum 108 used as image carrier, a cleaning blade 112 and the developing unit 113, for example.

The casing 111, detachably mountable in the housing 102, encases the charge roller 109, the photosensitive drum 108, the cleaning blade 112, and the developing unit 113, for example. The charge roller 109 uniformly charges the photosensitive drum 108. The photosensitive drum 108 faces a developing roller 115 of the developing unit 113 by setting a given gap therebetween. The photosensitive drum 108 may have a column-shape or cylindrical shape, which is rotatable about its axis.

When the charge photosensitive drum 108 is irradiated with a laser beam emitted from the respective optical writing units 122Y, 122M, 122C, and 122K, a latent image is formed on the photosensitive drum 108. The latent image on the photosensitive drum 108 is developed by the developing unit 113 as toner image, and then the toner image is transferred to the recording medium 107 transported by the transport belt 129. The cleaning blade 112 remove toners remaining on the photosensitive drum 108 after transferring the toner image to the recording medium 107.

A description is now given to the development unit 113 with reference to FIGS. 2 and 3. As illustrated in FIGS. 2 and 3, the development unit 113 includes an agent supply compartment 114, a casing 125, the developing roller 115 as developing agent carrier, and a doctor blade 116, for example.

The agent supply compartment 114 includes a container 117, and a pair of stirring screws 118 for agitating a developing agent 126. The container 117 may have a length, substantially matched to a length of the photosensitive drum 108. Further, the container 117 is provided with a separation wall 119, extending in a longitudinal direction of the container 117. The separation wall 119 separates the container 117 into a first compartment 120 and a second compartment 121. Further, the first and second compartments 120 and 121 are communicated with each other at their both end portions.

In the container 117, the developing agent 126 is contained in the first and second compartments 120 and 121. The developing agent 126 may include toner particles and the magnetic carrier made of magnetic particles. Fresh toner particles may be supplied to one end portion of the first compartment 120, which may be far from the developing roller 115, for example, in a timely manner. Toner particles may be fine spherical particles, prepared by emulsion polymerization method or suspension polymerization method, for example. Toner particles may also be prepared by pulverization method, in which synthetic resin mixed and dispersed with dyes or pigments may be pulverized. Toner particles may have an average particle diameter of from 3 μm to 7 μm, for example.

As above described, the magnetic carrier is contained in the first and second compartments 120 and 121. The magnetic carrier may have an average particle diameter of from 20 μm to 50 μm, for example. The magnetic carrier may include a core, a resin coat layer, and alumina particles, for example. An external surface of the core is coated with the resin coat layer, and the alumina particles are dispersed in the resin coat layer.

The core may be made of a magnetic material, such as ferrite, formed into a spherical shape, for example. The resin coat layer coats an external surface of the core. The resin coat layer may include resin such as, cross-linked resin (e.g., melamine resin and thermoplastic resin such as acrylic resin), and a charge control agent. Such resin coat layer has elasticity and strong adhesivity, for example. The alumina particles may have an outer diameter, set greater than a thickness of the resin coat layer, by which the alumina particles may protrude from a surface of the resin coat layer. The alumina particles are held in the resin coat layer by adhesivity of the resin coat layer.

The stirring screw 118, provided for the first and second compartments 120 and 121, respectively, has a longitudinal direction parallel to longitudinal directions of the container 117, the developing roller 115, and the photosensitive drum 108. The stirring screw 118, which is rotatable about its axial center, agitates toner particles and the magnetic carriers, and transports the developing agent 126.

Further, the stirring screw 118 in the first compartment 120 transports the developing agent 126 from the one end portion to other end portion, and the stirring screw 118 in the second compartment 121 transports the developing agent 126 from the other end portion to the one end portion.

In the agent supply compartment 114, toner particles supplied to the one end portion of the first compartment 120 are transported to the other end portion of the first compartment 120 while agitated with the magnetic carriers, and the agitated toner particles and the magnetic carriers are transported to the second compartment 121 from the other end portion of the first compartment 120. Then, in the agent supply compartment 114, toner particles and the magnetic carriers are agitatingly transported in the second compartment 121, and supplied to the external surface of the developing roller 115.

The casing 125, attached to the container 117 of the agent supply compartment 114, may encase the developing roller 115 or the like with the container 117. Further, the casing 125 has an opening 125, facing the photosensitive drum 108.

The developing roller 115, formed into a cylindrical shape, is provided between the second compartment 121 and the photosensitive drum 108, and adjacent to the opening 125a. The developing roller 115 is disposed parallel to the photosensitive drum 108 and the container 117. The developing roller 115 faces the photosensitive drum 108 with a given gap therebetween. The developing roller 115 and the photosensitive drum 108 form the developing area 131 at such gap portion, at which toner particles in the developing agent 126 are transferred and adhered to the photosensitive drum 108 to develop an electrostatic latent image formed on the photosensitive drum 108 as toner image.

As illustrated in FIGS. 2 to 5, the developing roller 115 includes a magnet roller 133 having a column-shape, and a developing sleeve 132 having a hollow cylindrical shape made of non-magnetic cylindrical body, for example.

As illustrated in FIG. 4, the magnet roller 133 includes a roller body 134, a magnet block 135, and a reinforcing member 136, for example. The roller body 134 is made of a magnetic material, the magnet block 135 is made of a rare earth material formed in a block shape, and the reinforcing member 136 is embedded in the roller body 134. The magnet block 135 and the reinforcing member 136 have a long shape extending in an axial direction of the magnet roller 133, for example.

The roller body 134 includes a shaft 134a protruding at its both end portions, wherein the shaft 134a has a column-shape. The shaft 134a is coaxially disposed with the roller body 134. As illustrated in FIG. 6, the roller body 134 is made of a solid body, and has a magnetic anisotropy that first magnetic field lines J1 becomes parallel one another in a cross-section face, perpendicular to an axial direction of the roller body 134. Further, the roller body 134 and the shaft 134a can be formed as one solid object.

As illustrated in FIG. 7, the roller body 134 includes a groove 137, which is a concaved groove extending in an axial direction of the roller body 134. As such, the roller body 134 is made as magnet solid body having a column-shape. The shaft 134a can be supported at a given position of the development unit 113 so that the roller body 134 does not rotate, which means that the magnet roller 133 is fixed at a given position in the development unit 113.

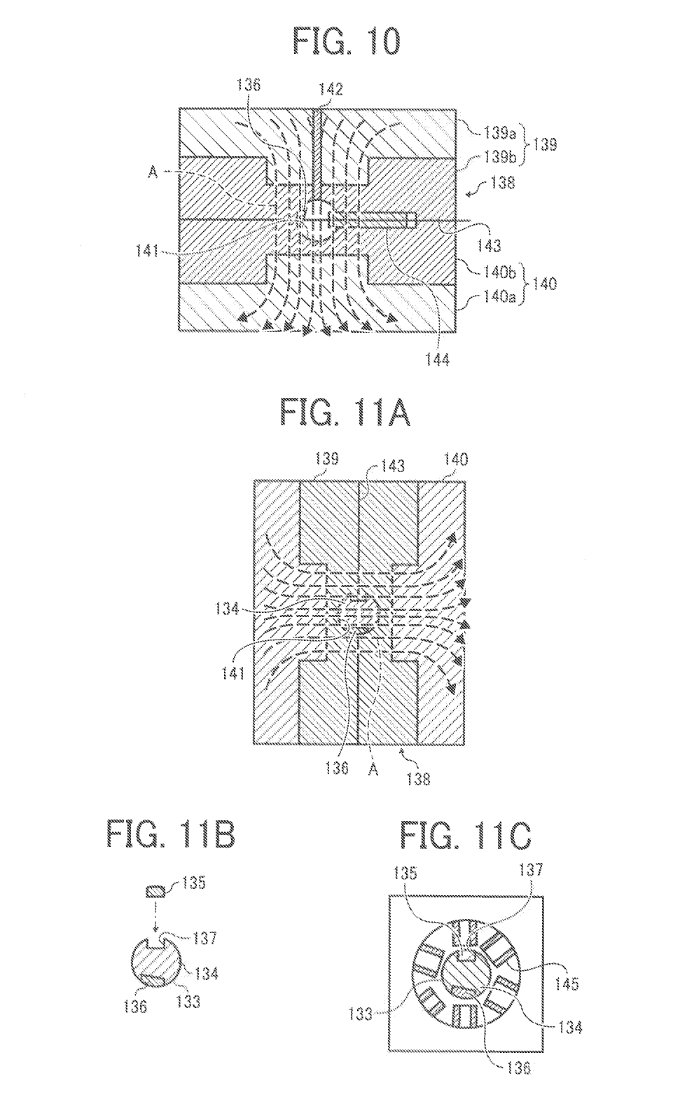

As described later, the roller body 134 can be formed by injecting and molding mixed materials composed of magnetic particles and polymer compound in a cavity 141 of an injection mold 138 having a given magnetic field orientation (refer to FIG. 10). As such, the roller body 134 may generally include a material such as, plastic magnet or rubber magnet. For example, magnetic particles may include ferrite compound, Ne compound (e.g., Ne—Fe), or Sm compound (e.g., Sm—Co, Sm—Fe—N) to obtain higher magnetic property such as, magnetic force. Polymer material may include PA (polyamide) material such as, 6PA or 12PA, ethylene compound such as, EEA (ethylene/ethyl copolymer), EVA (ethylene/vinyl copolymer), chlorinated material such as, CPE (chlorinated polyethylene), thermoplastic resin such as, rubber material (e.g., NBR), and thermosetting resin such as, epoxy, silicone, urethane resin.

In an exemplary embodiment, the roller body 134 is preferably made of mixed materials of PA (polyamide) resin having greater stiffness and ferrite magnet to set a diameter of the roller body 134 as small as possible, and resultantly to reduce a diameter of the magnet roller 133. The magnet block 135 is disposed at a given portion in the roller body 134, which needs a greater magnetic force. By forming the roller body 134 in a given magnetic field orientation to be described later, the roller body 134 can be formed to have magnetic force lines having magnetic anisotropy (i.e., magnetic particles are oriented in a given one orientation), by which the roller body 134 having an enhanced magnetic property can be formed.

As illustrated in FIGS. 4 and 6, the magnet block 135 may be formed in a bar or block shape having a substantially rectangular shape in its cross-sectional face. The magnet block 135 is disposed inside the groove 137, and has second magnetic field lines J2, which are substantially perpendicular to the first magnetic field lines J1 of the roller body 134 in a cross-sectional face, perpendicular to the axial direction of the roller body 134 as shown by arrows in FIG. 6.

The magnet block 135 may be made of mixed materials composed of PA (polyamide) polymer compound such as, 6PA, and magnetic particles such as, Nd—Fe—B or Sm—Fe—N, to obtain greater magnetic force with a smaller volume size. The magnet block 135 can be formed by injecting such mixed materials in a metallic mold using an injection molding process. Further, the magnet block 135 can be formed by using mixed materials composed of resin particles such as, polyester, and magnetic particles using an extrusion molding process or a compression molding process, for example.

As similar to the roller body 134, the magnet block 135 is preferably formed in a given magnetic field by an injection molding, an extrusion molding, or a compression molding, for example. With such process, magnetic force lines can be set as magnetic anisotropy, by which the magnet block 135 can have a higher greater magnetic property such as, magnetic force. The magnet block 135 is embedded in an outer portion of the roller body 134, wherein the outer portion may mean a portion closer to an external surface of the roller body 134. For example, the magnet block 135 is embedded in the groove 137 as shown in FIG. 4.

The magnet block 135 is configured as one magnetic pole used as development pole of the magnet roller 133 (to be described later) and has a greater magnetic force. The developing agent 126, accumulated on a surface of the developing sleeve 132 along magnetic force lines generated by the magnet roller 133, is transported to the development area 131 with a rotation of the developing roller 115.

The reinforcing member 136 is preferably made of a magnetic material having higher melting temperature and greater stiffness compared to the mixed materials used for the roller body 134. Accordingly, the reinforcing member 136 is made of a material different from the aforementioned mixed materials used for the roller body 134.

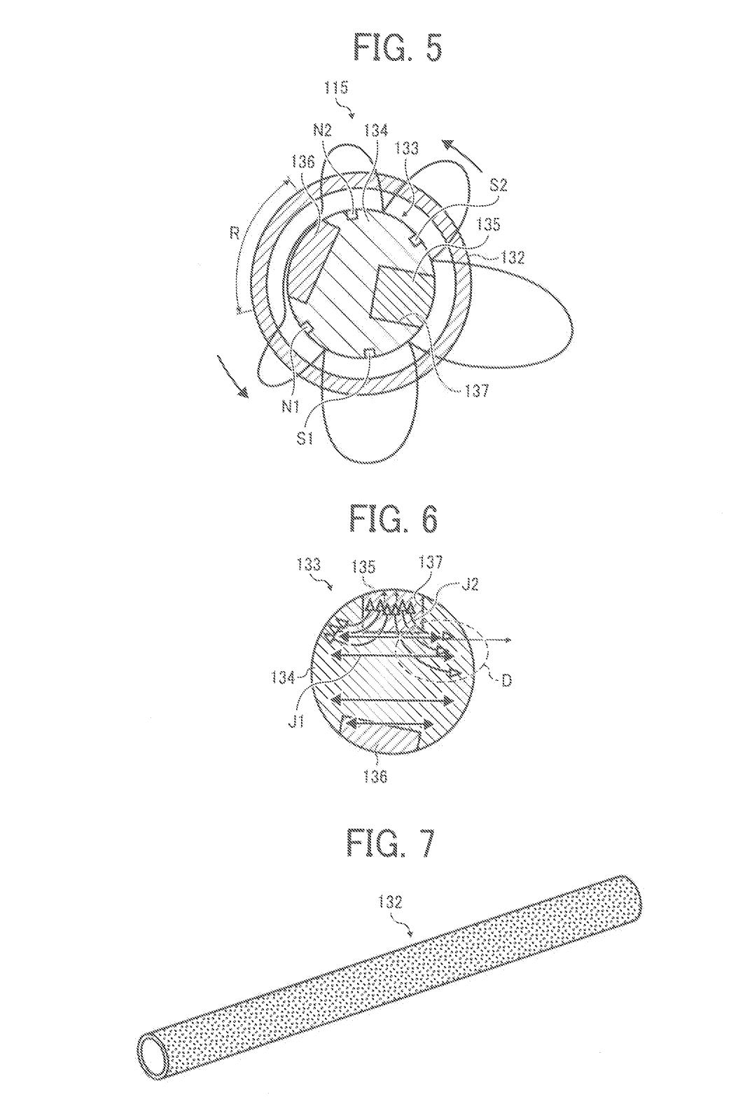

The reinforcing member 136 has a bar or block shape and a substantially rectangular shape in its cross-sectional face. The reinforcing member 136 is embedded in a given portion of the roller body 134 of the magnet roller 133 so that an external surface of the reinforcing member 136 forms a part of the surface of the magnet roller 133. The reinforcing member 136 extends in an axial direction of the roller body 134 of the magnet roller 133. As shown in FIG. 5, the reinforcing member 136 is embedded in a given portion of the roller body 134 so that the reinforcing member 136 is set in a portion corresponding to an agent releasing area R on the developing sleeve 132.

The reinforcing member 136 is made of a material including plastics, engineering plastics such as, polyamide (PA), polyacetal (POM), polycarbonate (PC), polybutylene terephthalate (PBT), and modified polyphenylene ether (PPE), super engineering plastics, ceramics, and metal, for example. The reinforcing member 136 is preferably made of super engineering plastics, ceramics, or metal to increase its stiffness. Further, if the reinforcing member 136 includes a given magnetic material, the developing agent 126 can be separated from the agent releasing area R of the developing roller 115 effectively.

Separation of the developing agent 126 is greatly effected by a repulsive force of magnetic poles adjacent to the reinforcing member 136. If the reinforcing member 136 is made of a non-magnetic material, magnetic poles adjacent to the reinforcing member 136 may be likely set to opposite magnetic poles each other, and thereby hard to set to same magnetic poles. If magnetic poles adjacent to the reinforcing member 136 have opposite magnetic poles each other, the developing sleeve 132 has a weaker repulsive magnetic field on its external surface, and thereby the developing agent 126 may be hard to be released or separated from the agent releasing area R.

Therefore, compared to using a non-magnetic material such as, aluminum base alloy, for the magnet roller 133, if the reinforcing member 136 is made of a magnetic material such as, iron, magnetic poles can be set in a suitable manner for the magnet roller 133 and stiffness of the magnet roller 133 can be enhanced.

Further, if the reinforcing member 136 is made of a material having higher melting temperature or higher thermosetting temperature compared to a material used for the roller body 134, the reinforcing member 136 can be set in the cavity 141 of the injection mold 138 when forming the roller body 134, to be described later. Although the roller body 134 can be formed by an extrusion molding or an injection molding, the roller body 134 is preferably formed by an injection molding because an outer diameter of the roller body 134 and an outer diameter of the shaft 134a have different sizes.

If the reinforcing member 136, formed of a material having higher melting temperature compared to a material used for the roller body 134, is set in the cavity 141 of the injection mold 138 when forming the roller body 134, and then the aforementioned mixed materials for forming the roller body 134 are injected in the injection mold 138 and then cooled, the roller body 134 and the reinforcing member 136 can be integrally formed by one molding process, by which a manufacturing process can be conducted with a shorter time, and the reinforcing member 136 can be fixed to the roller body 134 with a higher precision.

Further, by cooling the roller body 134 having integrally formed with the reinforcing member 136, a warping of the roller body 134 (or the magnet roller 133), which may occur during a cooling process, can be suppressed. In an exemplary embodiment, the reinforcing member 136 is made of a magnetic material having higher melting temperature and greater stiffness compared to a material used for the roller body 134, for example.

A description is given to magnetic poles of the magnet roller 133 with reference to FIG. 5. As illustrated in FIG. 5, the magnet roller 133 is encased coaxially in the developing sleeve 132, wherein the developing sleeve 132 is rotatable about its axis. The magnet roller 133 has a plurality of magnetic poles N1, S1, 135, S2, N2, and 136, which extend parallel to an axial direction of the magnet roller 133.

One of the magnetic poles is the magnet block 135, which faces the photosensitive drum 108. A magnetic pole generated by the magnet block 135 is used as “development pole,” at which magnetic carriers in the developing agent 126 are adhered on a skin or external surface of the developing sleeve 132 and toners in the developing agent 126 are supplied to the photosensitive drum 108, by which a latent image on the photosensitive drum 108 is developed. The magnet block 135 may be N pole and form a greater magnetic flux density over the external surface of the developing sleeve 132.

One of other magnetic poles is the reinforcing member 136, and the reinforcing member 136 is disposed to a position far from the photosensitive drum 108 as shown in FIG. 5. The reinforcing member 136 forms an agent releasing pole, at which the developing agent 126 used for developing process and remaining on the skin of the developing sleeve 132 is released or separated from the skin of the developing sleeve 132, and drops in the container 117.

The reinforcing member 136, provided between two magnetic poles N1 and N2 having N poles, forms a weaker N pole. Accordingly, the reinforcing member 136 forms the agent releasing pole having lower magnetic flux density, at which the developing agent 126 is released from the skin of the developing sleeve 132 to the container 117 with an effect of centrifugal force of the rotating developing sleeve 132, repulsive force of the magnetic poles N1 and N2, or gravity, for example.

In an exemplary embodiment, the reinforcing member 136 can be used for forming the “agent releasing pole” by setting a magnetic pole same as the magnetic pole N1 used as developing agent carry-up pole (to be described later) and the magnetic pole N2 used as developing agent transport pole (to be described later), wherein the magnetic poles N1 and N2 are adjacent to the reinforcing member 136. By setting the reinforcing member 136 between the magnetic poles N1 and N2 having same pole (e.g., N pole), the agent releasing area R having lower magnetic flux density can be effectively formed on the external surface of the developing sleeve 132.

The magnetic pole N1 adjacent to the reinforcing member 136 faces the container 117. Such magnetic poles N1 can be used as developing agent carry-up pole, which carries up the developing agent 126 from the container 117 to the skin of the developing sleeve 132. Such magnetic poles N1 having N pole forms a greater magnetic flux density over the external surface of the developing sleeve 132. The developing sleeve 132 may be rotated in a direction shown by an arrow in FIG. 5.

Further, at a downstream of a direction of rotation of the developing sleeve 132 with respect to the magnetic pole N1 used as developing agent carry-up pole and at a upstream of a direction of rotation of the developing sleeve 132 with respect to the magnet block 135 used as development pole, a magnetic pole S1 having S pole is disposed as a developing agent transport pole, by which the developing agent 126 is adhered on the skin of the developing sleeve 132 and transported.

Further, at a downstream of a direction of rotation of the developing sleeve 132 with respect to the magnet block 135 (or development pole) and at a upstream of a direction of rotation of the developing sleeve 132 with respect to the reinforcing member 136 (or agent releasing pole), magnetic poles S2 and N2 are disposed as developing agent transport poles, by which the developing agent 126 is adhered on the skin of the developing sleeve 132 and transported. In such two magnetic poles S2 and N2, the magnetic pole S2 closer to the magnet block 135 (or development pole) has S pole, and the magnetic pole N2 closer to the reinforcing member 136 has N pole, for example.

When the developing agent 126 adheres the skin of the developing sleeve 132, magnetic carriers in the developing agent 126 are stacked one another along magnetic force lines generated by the magnetic poles N1, S1, 135, S2, N2, and 136, by which magnetic carriers can form chains projected from the skin of the developing sleeve 132. Then, toner particles adhere on such chained magnetic carriers, and thereby the developing agent 126 adheres the skin of the developing sleeve 132 with an effect of magnetic force of the magnet roller 133.

A description is now given to a manufacturing of the magnet roller 133 with reference to FIG. 10. When manufacturing the magnet roller 133, the injection mold 138 shown in FIG. 10 is used. The injection mold 138 includes first and second molds 139 and 140 as two metallic molds. The first mold 139 includes a first magnetic mold 139a and a first non-magnetic mold 139b, and the second mold 140 includes a second magnetic mold 140a and a second non-magnetic mold 140b. The first and second non-magnetic molds 139b and 140b are respectively attached inside the first and second magnetic molds 139a and 140a. Then, by combining the first and second molds 139 and 140, a cavity 141 for forming the magnet roller 133 is set.

The first mold 139 also includes an injector pin 142 for removing the formed magnet roller 133 from the first mold 139. Further, at a parting line portion 143 of the first and second molds 139 and 140, a sliding member 144 is provided to form the groove 137 on the external surface of the magnet roller 133 when forming the magnet roller 133.

When forming the magnet roller 133, the reinforcing member 136 is set to a given position in the cavity 141 of the injection mold 138 having applied with a given magnetic field orientation shown by a flow direction A as illustrated in FIG. 10. While maintaining such magnetic field orientation (i.e., keep applying magnetic field), mixed materials composed of magnetic particles and polymer compound are injected in the cavity 141 of the injection mold 138. During such injection process, a magnetic field is set to flow from the first magnetic mold 139a of the first mold 139 to the second magnetic mold 140a of the second mold 140, by which the magnetic particles in the mixed materials can be oriented in the magnetic field flow shown by the flow direction A, and thereby the magnet roller 133 is formed to have magnetic anisotropy in one given orientation.

As illustrated in FIG. 11B, the magnet block 135 formed separately as bar or block shape is fixed in the groove 137 of the magnet roller 133 formed by the above described process. Then, the magnet roller 133 embedded with the magnet block 135 is disposed in a space surrounded by magnetism yokes 145 as illustrated in FIG. 11C to form the magnet roller 133 having a given magnetic force shown in FIG. 5, for example.

The magnet block 135 may be fixed to the magnet roller 133 using an adhesive agent, for example. Further, the magnet block 135 can be fixed to the magnet roller 133 after magnetizing the magnet roller 133 by the magnetism yokes 145.

In the above described manufacturing process, the roller body 134 and the reinforcing member 136 can be integrally formed by an injection molding (referred as insert molding), by which the reinforcing member 136 can be embedded in the roller body 134 at a given portion corresponding to the agent releasing area R of the developing sleeve 132. Further, the reinforcing member 136 can be fixed to the roller body 134 using an adhesive agent after forming the roller body 134 by an injection molding, for example.

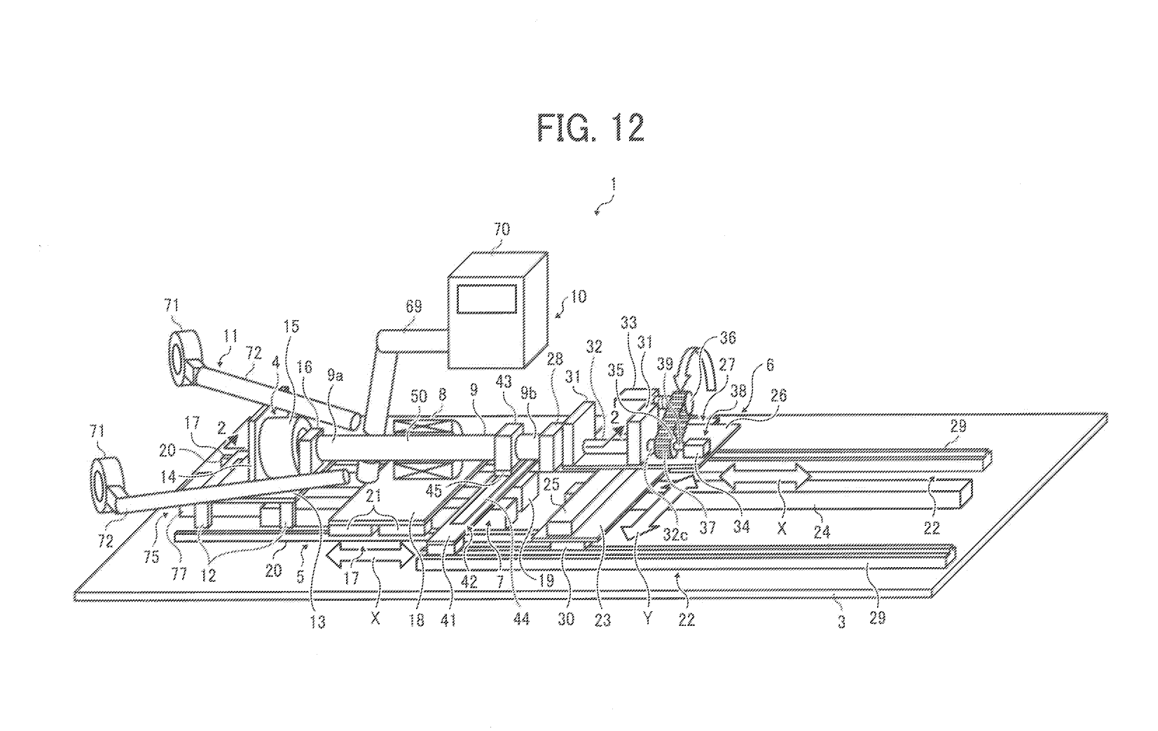

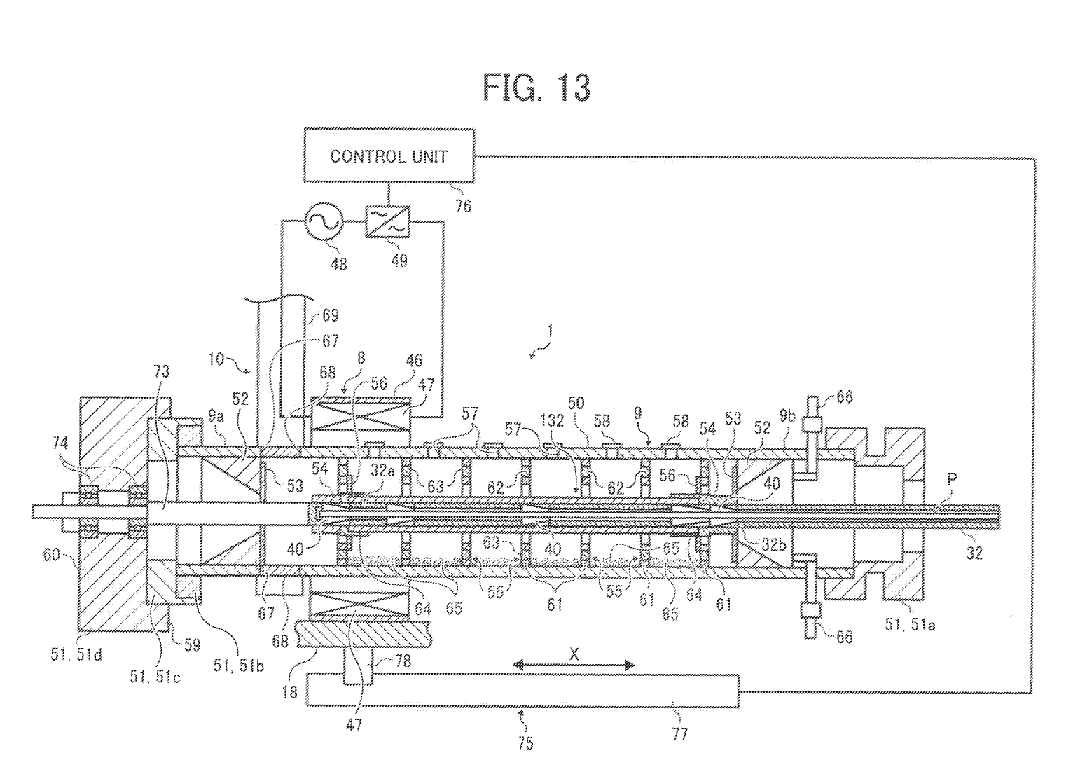

A description is given to the developing sleeve 132 with reference to FIG. 7. As illustrated in FIG. 7, the developing sleeve 132 has a cylindrical shape, for example. The developing sleeve 132 encases the magnet roller 133 therein, and can rotate about the axial center of the developing sleeve 132. Accordingly, the inner surface of the developing sleeve 132 sequentially faces each of the fixed magnetic poles N1, S1, 135, S2, N2, and 136 when the developing sleeve 132 rotates about its axis. The developing sleeve 132 may be made of a non-magnetic material such as, aluminum alloy, stainless steel (SUS) or the like. As described later, the skin of the developing sleeve 132 may be subjected to a roughing process by a surface treatment machine 1 (refer to FIG. 12) to make the skin as a preferably roughened surface.

As a base material of the developing sleeve 132, aluminum alloy may be preferably used from a viewpoint of its machinability and lightweight. When aluminum alloy is used as base material of the developing sleeve 132, aluminum alloy having standard of A6063, A5056, or A3003 may be preferably used, for example. When SUS (stainless steel) is used, SUS 303, SUS 304, or SUS 316 may be preferably used, for example.

The developing sleeve 132 may have a given outer diameter such as, 17 mm to 18 mm and a given axial length such as, 300 mm to 350 mm, for example. The size of the developing sleeve 132 may be changed to any values depending on a design concept or the like. The skin of the developing sleeve 132 has a given surface roughness, which may vary depending on a surface portion of the developing sleeve 132. For example, a depth of depressions formed on the developing sleeve 132 may become gradually deeper in an axial direction, which starts from a center portion to an each end portion of the developing sleeve 132.

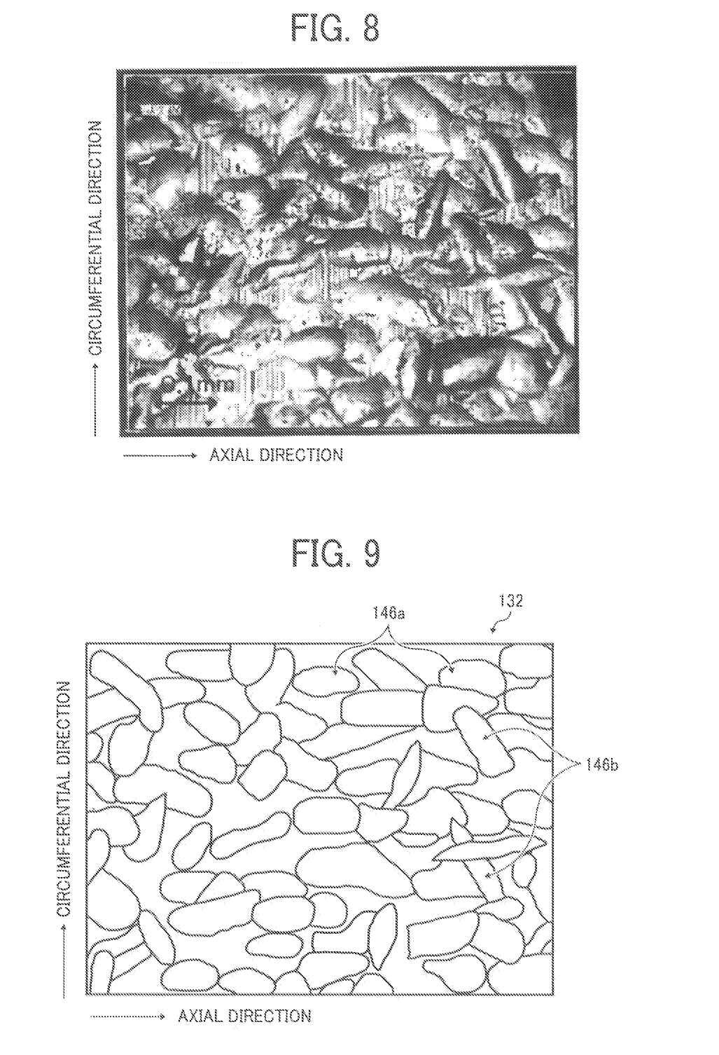

Further, as illustrated FIGS. 8 and 9, the skin of the developing sleeve 132 has a number of depressions 146 having elliptical shape when viewed from above the developing sleeve 132. As illustrated FIGS. 8 and 9, such depressions 146 are randomly formed on the skin of the developing sleeve 132. As illustrated FIGS. 8 and 9, the depressions 146 may have two types of depressions, that is, first depressions 146a and second depressions 146b.

In the first depressions 146a, a major axis of elliptical shape may be substantially aligned in an axial direction of the developing sleeve 132. In the second depressions 146b, a major axis of elliptical shape may be substantially aligned in a circumferential direction of the developing sleeve 132, wherein the circumferential direction of the developing sleeve 132 is a rotation direction of the developing sleeve 132 in this disclosure. In an exemplary embodiment, the developing sleeve 132 may have a greater number of the first depressions 146a compared to the second depressions 146b, for example. Further, the depressions 146 having elliptical shape may have a given major axis length of such as, from 0.05 mm to 0.3 mm, and a given minor axis length of such as, from 0.02 mm to 0.1 mm, for example. As illustrated in FIGS. 8 and 9, the axial direction and the circumferential direction of the developing sleeve 132 are perpendicular with each other. Because the developing sleeve 132 has such greater number of depressions on its skin, the skin of the developing sleeve 132 is formed with a greater number of concavities and convexities as a whole.

The doctor blade 116, attached to the casing 125, is disposed over the external surface of the developing sleeve 132 with a given gap, and may be disposed adjacent to the photosensitive drum 108 in the development unit 113. The doctor blade 116 scrapes the developing agent 126, supplied on the skin of the developing sleeve 132, to control an amount of the developing agent 126 at a given level, by which a given amount of developing agent 126 can be reliably transported to the developing area 131.

The developing agent 126 may be transported to the developing area 131 in the development unit 113 as follows. In the development unit 113, toner particles and the magnetic carrier 135 are agitated in the agent supply compartment 114, and the agitated developing agent 126 is then attracted on the skin of the developing sleeve 132 with an effect of the magnetic pole N1 in the developing roller 115. With a rotation of the developing sleeve 132, such attracted developing agent 126 is transported to the developing area 131 with an effect of the magnetic pole S1. After controlling a thickness of the developing agent 126 with the doctor blade 116, the developing agent 126 is adhered onto the photosensitive drum 108. With such processes, an electrostatic latent image on the photosensitive drum 108 is developed with the developing agent 126 as toner image.

After such developing process, the developing agent 126 remaining on the developing roller 115 are transported by the magnetic poles S2 and N2, and removed and recovered at the agent releasing area R into the container 117. Such recovered developing agent 126 is then agitated with the developing agent 126 in the second compartment 121, and further used as developing agent for developing another electrostatic latent image on the photosensitive drum 108.

The image forming apparatus 101 forms an image on the recording medium 107 as below. First, the charge roller 109 uniformly charges a surface of the photosensitive drum 108, rotating in a given direction. The surface of the photosensitive drum 108 is irradiated with a laser beam to form a latent image on the photosensitive drum 108. When the latent image comes to the development area 131, the developing unit 113 develops the latent image on the photosensitive drum 108 by adhering the developing agent 126 as toner image, wherein the developing agent 126 is transported on the skin of the developing sleeve 132.

Then, the recording medium 107, transported by the feed roller 124 of the sheet feed unit 103, is fed to a position between the photosensitive drum 108 of the process cartridges 106Y, 106M, 106C, and 106K and the transport belt 129 of the transfer unit 104 to transfer the toner image from the photosensitive drum 108 to the recording medium 107. Then the toner images are fixed on the recording medium 107 by the fusing unit 105, by which the image forming apparatus 101 forms a color image on the recording medium 107.

A description is now given to a surface treatment machine and magnetic wire members for forming depressions having elliptical shape on a skin or external surface of the developing sleeve 132 of the developing roller 115 with reference to FIGS. 12 to 17, in which wire members 65 impact against the skin of the hollow structure (i.e., developing sleeve 132) to form depressions on the developing sleeve 132.

As illustrated in FIGS. 12 and 13, the surface treatment machine 1 includes a base 3, a fixed holding unit 4, a electromagnetic coil moving unit 5, a movable holding unit 6, a movable chuck unit 7, an electromagnetic coil 8, a container unit 9, a collection unit 10, a cooling unit 11, a linear encoder 75, and a control unit 76, for example.

The base 3 is formed into a plate-like shape, and is installed on a floor, a table or the like in a factory. The base 3 has an upper face maintained parallel to the horizontal direction. The base 3 is formed into a rectangular shape, for example.

The fixed holding unit 4 includes a plurality of columns 12, a holding base 13, a standing bracket 14, a cylindrical holding member 15, and a holding chuck 16. The columns 12 may be standing on the base 3, for example.

The holding base 13 is formed into a plate-like shape, and attached to an upper end portion of the columns 12. The standing bracket 14, formed into a plate-like shape, protrudes from the holding base 13.

The cylindrical holding member 15, formed into a cylindrical shape, is attached to the standing bracket 14 and the holding base 13. The cylindrical holding member 15 is disposed closer to a center portion of the base 3 compared to the standing bracket 14, and the axial center of the cylindrical holding member 15 is parallel to the horizontal direction and the direction shown by an arrow X. The cylindrical holding member 15 houses the flange 51b, 51c, and 51d (to be described later) attached to a first end portion 9a (to be described later) of the container unit 9.

The holding chuck 16, disposed near the cylindrical holding member 15 and the holding base 13, is attached to the base 3. The holding chuck 16 chucks the container unit 9 having the first end portion 9a, housed in the cylindrical holding member 15, to hold the first end portion 9a of the container unit 9. The fixed holding unit 4 also holds the first end portion 9a of the container unit 9.

The electromagnetic coil moving unit 5 includes a pair of linear guides 17, an electromagnetic coil holding base 18, an electromagnetic coil moving actuator 19. The linear guides 17 include rails 20, and a slider 21. The rails 20 are installed on the base 3. The rails 20, formed into a straight line shape, are disposed to parallel to the longitudinal direction (or an arrow X) of the base 3. The slider 21 is slidably supported on the rails 20 in the longitudinal direction (or an arrow X) of the rails 20. In the pair of the linear guides 17, the rails 20 are arranged with a given distance each other in a width direction (hereinafter, refer to an arrow Y) of the base 3. The arrow X and the arrow Y are perpendicular to each other, and parallel to the horizontal direction.

The electromagnetic coil holding base 18, formed into a plate-like shape, is attached to the slider 21. The electromagnetic coil holding base 18 has an upper face, which is parallel to the horizontal direction. The electromagnetic coil holding base 18 holds the electromagnetic coil 8 thereon.

The electromagnetic coil moving actuator 19, attached to the base 3, is used to slidably move the electromagnetic coil holding base 18 in the direction of the arrow X.

The electromagnetic coil moving unit 5 slidably moves the electromagnetic coil holding base 18 and the electromagnetic coil 8 in the direction of the arrow Y by using the electromagnetic coil moving actuator 19. Further, the electromagnetic coil moving unit 5 can change a moving speed of the electromagnetic coil 8 in a range of from 0 mm/sec to 300 mm/sec, for example. Further, the electromagnetic coil moving unit 5 can move the electromagnetic coil 8 in a movable range of 600 mm or so.

The movable holding unit 6 includes a pair of linear guides 22, a holding base 23, a first actuator 24, a second actuator 25, a moving base 26, a bearing rotation unit 27, and a holding chuck 28.

The linear guides 22 include rails 29 and the slider 30. The rails 29 are installed on the base 3. The rails 29, formed into a straight line shape, are disposed parallel to the longitudinal direction (or the arrow X) of the base 3. The slider 30 is slidably supported on the rails 29 in the longitudinal direction (or the arrow X) of the rails 29. The pair of the linear guides 22 are arranged with a given distance each other in the width direction (or the direction shown by the arrow Y) of the base 3.

The holding base 23, formed into a plate-like shape, is attached to the slider 30. The holding base 23 has an upper face, which is parallel to the horizontal direction. The first actuator 24, attached to the base 3, is used to slidably move the holding base 23 in the direction of the arrow X.

The second actuator 25, attached to the holding base 23, is used to slidably move the moving base 26 in the direction of the arrow Y. The moving base 26, formed into a plate-like shape, has an upper face, which is parallel to the horizontal direction.

The bearing rotation unit 27 includes a pair of bearings 31, a hollow object holding member 32, a drive motor 33, a chuck cylinder 34. The pair of bearings 31, arranged with a given distance each other in the direction of the arrow X, are installed on the moving base 26.

The hollow object holding member 32 is made of a magnetic material, and formed into a cylindrical shape. The hollow object holding member 32, supported by the bearings 31, is rotatable about its axial center. The hollow object holding member 32 has its axial center, which is arranged parallel to the axial center of the cylindrical holding member 15 or the direction of the arrow X. The hollow object holding member 32 has a first end portion 32a (see FIG. 13), which is inserted in the container unit 9, and a second end portion 32c (see FIG. 12) disposed over the moving base 26. As illustrated in FIG. 13, the hollow object holding member 32 is inserted in the developing sleeve 132 having a cylindrical shape. Further, the second end portion 32c of the hollow object holding member 32 is fixed to a pulley 35 placed over the moving base 26. The pulley 35 is disposed coaxially with the hollow object holding member 32.

The drive motor 33, installed on the moving base 26, has an output shaft attached to a pulley 36. The output shaft of the drive motor 33 has an axial center, which is parallel to the direction of the arrow X. A timing belt (or endless belt) 37 is extended by the pulleys 35 and 36. The drive motor 33 rotates the hollow object holding member 32 about its axis. By rotating the hollow object holding member 32, the drive motor 33 can rotate the developing sleeve 132 about its axis.

The chuck cylinder 34 includes a cylinder body 38 and a chuck shaft 39, wherein the cylinder body 38 is mounted on the moving base 26, and the chuck shaft 39 is slidably provided to the cylinder body 38. The chuck shaft 39, formed into a cylindrical shape, is disposed parallel to the direction of the arrow X. The chuck shaft 39 is arranged coaxially with the hollow object holding member 32 and encased in the hollow object holding member 32. The chuck shaft 39 is provided with a plurality of chuck claws 40, which are arranged as a pair of the chuck claws.

The chuck claws 40 are protrudingly attached on an outer circumference face of the chuck shaft 39. Further, the chuck claws 40 may protrude from an outer circumference face of the hollow object holding member 32 in an outer direction of the hollow object holding member 32. A protruding amount of the chuck claws 40 from the chuck shaft 39 and the hollow object holding member 32 can be changeable. The chuck claws 40 are arranged in the longitudinal direction of the chuck shaft 39 with a given distance each other. As the chuck shaft 39 moves toward the cylinder body 38, the protruding amount of the chuck claws 40 from the chuck shaft 39 and the hollow object holding member 32 increases.

When the chuck shaft 39 moves toward the cylinder body 38, the chuck claws 40 can be more protruded from the outer circumference face of the chuck shaft 39, by which the chuck claws 40 are pressed to an inner surface of the developing sleeve 132, attached to the outer circumference face of the hollow object holding member 32. With such process, the chuck shaft 39, the hollow object holding member 32, and the developing sleeve 132 are fixed together. At this time, the chuck shaft 39, the hollow object holding member 32, the developing sleeve 132, a cylindrical member 50 (to be described later), and the container unit 9 are coaxially arranged.

The chuck cylinder 34 and the chuck claws 40 are used to hold the hollow object holding member 32, the container unit 9, and the developing sleeve 132 coaxially. Accordingly, the chuck cylinder 34 and the chuck claws 40 hold the developing sleeve 132 in a center position of the container unit 9 in an axial direction of the container unit 9.

The holding chuck 28 is installed on the moving base 26. The holding chuck 28 chucks a flange 51a (to be described later) attached to a second end portion 9b of the container unit 9 to hold the second end portion 9b of the container unit 9. The holding chuck 28 regulates or restricts a rotation of the container unit 9 about its axial center.

The movable holding unit 6 moves the holding chuck 28, the hollow object holding member 32 in perpendicular directions (e.g., directions shown by the arrows X and Y) using the above-described actuators 24 and 25. Accordingly, the movable holding unit 6 moves the container unit 9, held by the holding chuck 28 in the perpendicular directions (e.g., directions shown by the arrows X and Y).

The movable chuck unit 7 includes a holding base 41, a linear guide 42, and a holding chuck 43. The holding base 41 is fixed to one end portion of the rails 29 of the linear guides 22, wherein such one end portion is closer to the fixed holding unit 4. The holding base 41, formed into a plate-like shape, has an upper face, which is parallel to the horizontal direction.

The linear guide 42 may include rails 44 and a slider 45. The rails 44 are installed on the holding base 41. The rails 44, formed into a straight line shape, are disposed parallel to the width direction (or the direction of the arrow Y) of the base 3. The slider 45 is slidably supported on the rails 44 in the longitudinal direction (or the direction of the arrow Y) of the rails 44.

The holding chuck 43 is installed on the slider 45. The holding chuck 43 is placed between the holding chucks 16 and 28. The holding chuck 43 chucks the container unit 9 at a portion closer to the second end portion 9b to hold the container unit 9. The movable chuck unit 7 is used to position the container unit 9 at a given position when the holding chuck 43 holds the container unit 9. Further, when the holding chuck 43 holds the container unit 9, the movable chuck unit 7 and the holding chuck 28 cooperates together to hold the container unit 9 during a movement of the container unit 9 in its axial direction so that the container unit 9 does not drop from the bearing rotation unit 27 and the surface treatment machine 1.

As illustrated in FIG. 13, the electromagnetic coil 8 includes an outer cover 46 and a coil unit 47. The outer cover 46, formed into a cylindrical shape, encases the coil unit 47. The electromagnetic coil 8 has an inner diameter greater than an outer diameter of the container unit 9. Accordingly, a space is formed between inner surface of the electromagnetic coil 8 and the outer circumference face of the container unit 9. Further, a total length of the electromagnetic coil 8 is smaller than a total length of the container unit 9. Preferably, the total length of the electromagnetic coil 8 is set two thirds (⅔) or less of the total length of the container unit 9. For example, the electromagnetic coil 8 has an inner diameter of 90 mm and a length of 85 mm.

The outer cover 46 is attached to the electromagnetic coil holding base 18 while aligning the axial center of the outer cover 46 to the axial center of the electromagnetic coil 8. The electromagnetic coil 8 is arranged coaxially with the hollow object holding member 32, the chuck shaft 39, and the container unit 9.

The coil unit 47 may include coils, arranged along the circumferential direction of the outer cover 46 (or the electromagnetic coil 8). As illustrated in FIG. 13, the coil unit 47 is applied with current by a three-phase alternating current source 48. The coils of the coil unit 47, applied with current having different phases, generate magnetic fields having different phases. The electromagnetic coil 8 combines such magnetic fields to form a magnetic field (hereinafter referred as “rotated magnetic field”) having a direction of rotation in the electromagnetic coil 8 about its axial center.

The electromagnetic coil 8, applied with current from the three-phase alternating current source 48 to generate such rotated magnetic field, is moved in the axial direction of the electromagnetic coil 8 (or longitudinal direction of the container unit 9) by the electromagnetic coil moving unit 5.

The electromagnetic coil 8 uses such rotated magnetic field to position wire members 65, contained in the container unit 9, to the outer circumference face of the developing sleeve 132, and to rotate (or move) the wire members 65 inside the container unit 9 and around the developing sleeve 132. The wire members 65 may be a group of a greater number of small pieces made of magnetic material. With such configuration, the electromagnetic coil 8 induces the wire members 65 to impact against the skin of the developing sleeve 132 by using such rotated magnetic field.

Further, an inverter 49 is provided between the three-phase alternating current source 48 and the electromagnetic coil 8 for changing a magnetic field strength. The inverter 49 can change frequency, current value, and voltage value of power applied to the electromagnetic coil 8 by the three-phase alternating current source 48. By changing frequency, current value, and voltage value of power applied to the electromagnetic coil 8 by the inverter 49, power applied to the electromagnetic coil 8 from the three-phase alternating current source 48 can be increased or decreased to change a rotated magnetic field strength generated by the electromagnetic coil 8.

As illustrated in FIG. 13, the container unit 9 may include a cylindrical member 50, a plurality of flanges 51, a pair of shaving-seal holders 52, a pair of shaving-seal plates 53, a pair of positioning members 54, a plurality of partitioning members 55, and a pair of seal plates 56, for example.

The cylindrical member 50, formed into a cylindrical shape, is used as an outer envelope of the container unit 9 and has a single wall structure. Accordingly, the container unit 9 may have an outer shell having a cylindrical shape of single wall structure. For example, the cylindrical member 50 of the container unit 9 preferably has an outer diameter of from 40 mm to 80 mm, and a thickness of from 0.5 mm to 2.0 mm. Further, the cylindrical member 50 preferably has an axial direction length of from 600 mm to 800 mm, for example. The cylindrical member 50 may be made of a nonmagnetic material, for example.

The cylindrical member 50 is provided with a plurality of the wire member supply holes 57. Each of the wire member supply holes 57 passes through the cylindrical member 50 so that the outside and the inside of the cylindrical member 50 can be communicated with each other. Each of the wire member supply holes 57 is attached with a seal cap 58. The wire member supply holes 57 are used to take in the wire members 65 into the inside of the cylindrical member 50 or to eject the wire members 65 to the outside of the cylindrical member 50. The seal cap 58 caps each of the wire member supply holes 57 so that the wire members 65 do not run out from the cylindrical member 50 of the container unit 9.

The plurality of flanges 51 may be formed into a circular shape or a cylindrical shape, for example. In an exemplary embodiment, the plurality of flanges 51 includes four flanges, for example, and three of them (hereinafter, the flange 51b, 51c, and 51d) are attached to the first end portion 9a of the cylindrical member 50, and one of them (hereinafter, the flange 51a) is attached to the second end portion 9b of the cylindrical member 50.

The flange 51b, formed into a circular shape, engages an outer circumference of the cylindrical member 50. The flange 51c, formed into a circular shape, engages an outer circumference of the flange 51b. The flange 51d may integrally include a ring portion 59 having a circular shape and a column portion 60 having a cylindrical shape, in which the ring portion 59 may be protruded from an outer edge of the column portion 60. The ring portion 59 of the flange 51d engages an outer circumference of the flange 51c.

As illustrated in FIG. 13, the flange 51d rotatably supports a driven shaft 73 with a bearing 74. The driven shaft 73, formed into a cylindrical shape, is disposed coaxially with the cylindrical member 50 of the container unit 9. The driven shaft 73 has one end face, which is pressed to the hollow object holding member 32. The driven shaft 73, which rotates with the hollow object holding member 32, supports the first end portion 32a (or free end side) of the hollow object holding member 32.

As illustrated in FIG. 13, the flange 51a, formed into a circular shape, engages an outer circumference of the second end portion 9b of the cylindrical member 50, wherein the hollow object holding member 32 passes through the flange 51a. The first end portion 9a of the cylindrical member 50 is used as one end portion of the container unit 9, and the second end portion 9b of the cylindrical member 50 is used as other end portion of the container unit 9.

Each of the shaving-seal holders 52 is formed into a circular shape. One of the shaving-seal holders 52 engages an inner circumference of the first end portion 9a of the cylindrical member 50, and other shaving-seal holder 52 engages an inner circumference of the second end portion 9b of the cylindrical member 50, wherein the hollow object holding member 32 passes through the other shaving-seal holder 52.

Each of the shaving-seal plates 53 is formed into a mesh-like shape. One of the shaving-seal plates 53, formed into a circular shape, is disposed in the inner circumference of the first end portion 9a of the cylindrical member 50 and attached to the one of the shaving-seal holders 52. Further, the driven shaft 73 passes through the one of the shaving-seal plate 53.

Other shaving-seal plate 53, formed into a circular shape, is disposed in the inner circumference of the second end portion 9b of the cylindrical member 50 and attached to the other shaving-seal holder 52. The hollow object holding member 32 passes through the other shaving-seal plate 53.

The shaving-seal plates 53 prevents shavings (e.g., shaved chip) getting out of the cylindrical member 50 of the container unit 9 when shavings are generated by shaving the skin of the developing sleeve 132 with the impacted wire members 65.

Each of the positioning members 54 is formed into a cylindrical shape. One of the positioning members 54 engages the outer circumference of the first end portion 32a of the hollow object holding member 32. Other positioning member 54 engages the outer circumference of a center portion 32b of the hollow object holding member 32, which is closer to the second end portion 9b of the container unit 9.

The pair of the positioning members 54 sandwich the developing sleeve 132 therebetween to position the developing sleeve 132 at a given position in the hollow object holding member 32. The first end portion 32a of the hollow object holding member 32 is positioned closer to the fixed holding unit 4 and far from the movable holding unit 6. The center portion 32b of hollow object holding member 32, positioned in the container unit 9, is far from the fixed holding unit 4 and closer to the movable holding unit 6.

The partitioning member 55 may include a frame 61, formed into a circular shape, and a mesh portion 62. The frame 61 engages and attaches the inner circumference of the cylindrical member 50, wherein the hollow object holding member 32 passes through the frame 61. As illustrated in FIG. 13, a plurality of the partitioning members 55, is disposed between the pair of the shaving-seal plates 53 with a given distance each other in the longitudinal direction of the cylindrical member 50. In FIG. 13, seven partitioning members 55 are provided, for example.

The frame 61 may include a through hole 63, to which the mesh portion 62 is attached. The mesh portion 62, formed into a mesh-like shape, allows a passage of gas and shavings (e.g., shaved chip) but do not allow a passage of the wire members 65 therethrough.

The partitioning members 55 partition or segment a space in the cylindrical member 50 of the container unit 9 in an axial direction of the developing sleeve 132. The frame 61 and the mesh portion 62 of the partitioning member 55 are made of a nonmagnetic material.

Further, the developing sleeve 132 has the rotation center P, which may be aligned to the axial center of the container unit 9 and the hollow object holding member 32. Accordingly, the rotation center P of the developing sleeve 132 and the longitudinal direction of the container unit 9 are set parallel to each other.

The seal plate 56, formed into a circular shape, is further formed into a mesh-like shape to allow a passage of gas (e.g., air) and the above-described shavings (e.g., shaved chip) but not allow a passage of the wire members 65. One of the seal plates 56 is attached to one of the partitioning members 55, which is closest to the first end portion 9a, and other seal plate 56 is attached to another one of the partitioning members 55, which is closest to the second end portion 9b. A cap sleeve 64 (to be described later), attached to both end of the developing sleeve 132, passes through each of the seal plates 56. The seal plates 56 may be used to prevent the wire members 65 getting out from the cylindrical member 50 of the container unit 9, w herein the wire members 65 are contained in spaces partitioned or segmented by the partitioning members 55.

The container unit 9 contains the wire members 65, made of magnetic material, in spaces partitioned or segmented by the plurality of the partitioning members 55, and contains the developing sleeve 132, attached to the hollow object holding member 32, in the cylindrical member 50. Accordingly, the container unit 9 contains the developing sleeve 132 and the wire members 65 therein.

Further, the wire members 65, rotated (or moved) by the above-described rotated magnetic field, may impact against the skin of the developing sleeve 132. When the wire members 65 impact against the skin of the developing sleeve 132, parts of the skin of the developing sleeve 132 are shaved by such impact, by which the skin of the developing sleeve 132 is roughened.

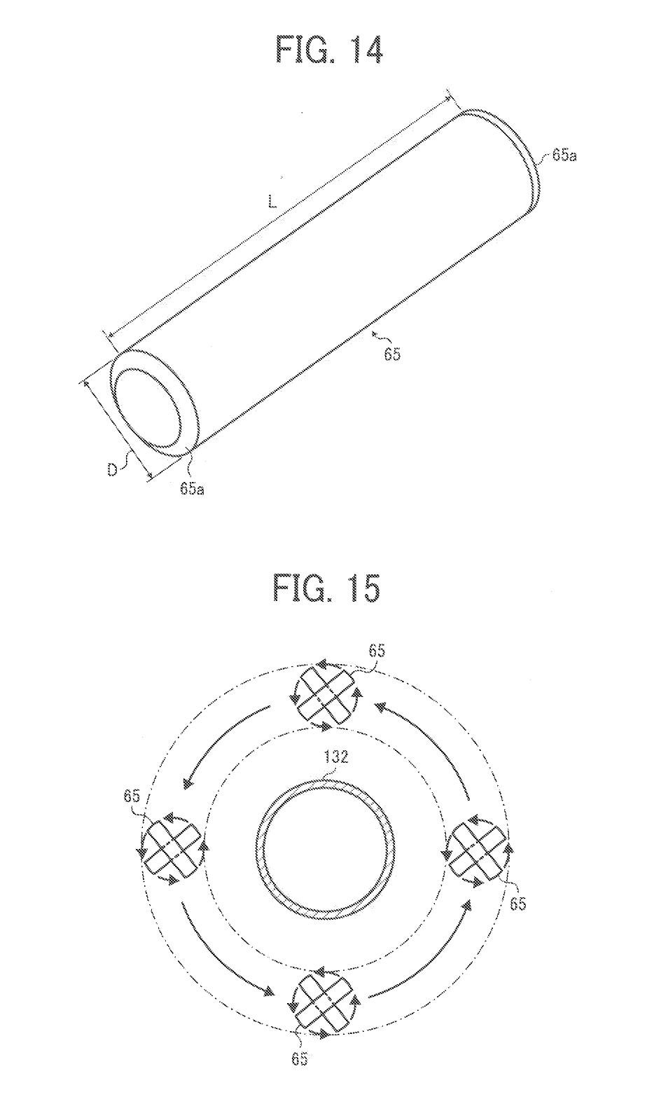

A description is now given to the wire members 65, used for the surface treatment machine 1 with reference to FIG. 14. As illustrated in FIG. 14, the wire member 65 has a cylindrical-like shape having a relatively short length. The wire member 65 may be made of a magnetic material such as, austenitic stainless steel, martensitic stainless steel, or the like, for example. Although austenitic stainless steel may be generally used as non-magnetic material, austenitic stainless steel may be provided with magnetic property by processing austenitic stainless steel with a cold work or the like, in which austenitic stainless steel may become martensitic stainless steel having magnetic property. Because such austenitic stainless steel or martensitic stainless steel are materials available on the market, the wire members 65 can be preferably fabricated with austenitic stainless steel or martensitic stainless steel with reasonable cost or a reduced cost.

The wire member 65 may have a cylinder-like shape having a given dimension, which can be made by cutting a wire into small pieces, for example. Such wire member 65 may have an outer diameter of from 0.5 mm to 12 mm, for example. When the wire member 65 has a total length L and an outer diameter D, the wire member 65 may be formed into a shape having a L/D ratio of from 4 to 10, for example.

Further, as illustrated in FIG. 14, the outer edge 65a of the wire member 65 is chamfered around its periphery and has a circular arc shape in a cross sectional view. The outer edge 65a is formed to have a given curvature radius r of from 0.05 mm to 0.2 mm, for example.

As illustrated in FIG. 15, with an effect of rotated magnetic field generated in the surface treatment machine 1, the wire member 65 rotates about its center of its longitudinal direction while rotatingly moving along the circumferential direction of the developing sleeve 132 and the container unit 9.

As illustrated FIG. 13, the collection unit 10 includes a gas inflow tube 66, a gas ejection hole 67, a mesh member 68, a gas ejection duct 69, and a dust collector 70 (see FIG. 12). As illustrated FIG. 13, the gas inflow tube 66 is disposed into a given position of the cylindrical member 50, which is closer to the above-described other shaving-seal holder 52 and one end of the container unit 9, closer to the movable holding unit 6. The gas inflow tube 66 has an orifice, inserted in the cylindrical member 50 of the container unit 9. The gas inflow tube 66 is used to supply pressurized gas (e.g., air) to the cylindrical member 50 from a pressurized gas supply source (not shown).

The gas ejection hole 67 passes through the cylindrical member 50 so that the inside and outside of the container unit 9 are communicated with each other, and is provided to a given position between the above-described one of the shaving-seal holders 52 and an end portion of the cylindrical member 50 of the container unit 9, which are far from the movable holding unit 6. The mesh member 68 is disposed to the gas ejection hole 67 provided to the cylindrical member 50. The mesh member 68 allows a passage of shavings (e.g., shaved chip) and gas, but do not allow a passage of the wire members 65. Accordingly, the mesh member 68 prevents the wire members 65 getting out from the cylindrical member 50 of the container unit 9.

The gas ejection duct 69, formed in a tube shape, is attached to a near of the gas ejection hole 67. The gas ejection duct 69 encircles the outer edge of the gas ejection hole 67. The gas ejection hole 67 and the gas ejection duct 69 are used to guide gas, supplied to the cylindrical member 50 from the gas inflow tube 66, to the outside of the cylindrical member 50 of the container unit 9.

The dust collector 70, coupled to the gas ejection duct 69, sucks in gas from the gas ejection duct 69. By sucking gas from the gas ejection duct 69, the dust collector 70 sucks in the above-described shavings (e.g., shaved chip) from the cylindrical member 50 of the container unit 9 to collect the shavings (e.g., shaved chip). As such, the collection unit 10 collects the shavings (e.g., shaved chip) from the cylindrical member 50 of the container unit 9.

As illustrated in FIG. 12, the cooling unit 11 includes a cooling fan 71, and a cooling duct 72. The cooling fan 71 supplies pressurized gas (e.g., air) to the cooling duct 72, which is a tube. The cooling duct 72 guides pressurized gas (e.g., air) supplied from the cooling fan 71 to the electromagnetic coil 8, and blows pressurized gas (e.g., air) to the electromagnetic coil 8. By blowing the pressurized gas (e.g., air) to the electromagnetic coil 8, the cooling unit 11 cools the electromagnetic coil 8.

As illustrated in FIG. 13, the linear encoder 75 includes a body 77 and a detection member 78 slidably disposed to the body 77. The body 77 may have straight line shape and attached to the base 3. The body 77 is arranged between the pair of rails 20, in which the body 77 is parallel to the rails 20. The body 77 has a total length, which is longer than that of the container unit 9. The body 77 may have its both end portions, which may protrude from both end portions of the container unit 9 in the longitudinal direction of the container unit 9.

The detection member 78 is slidably provided on the body 77 in the longitudinal direction of the container unit 9. The detection member 78 is attached to the electromagnetic coil holding base 18. Accordingly, the detection member 78 is coupled to the electromagnetic coil 8 via the electromagnetic coil holding base 18.

The linear encoder 75 detects a position of the detection member 78 with respect to the body 77 (or the container unit 9), and outputs a detection result signal to the control unit 76. As such, the linear encoder 75 detects a relative position of the electromagnetic coil 8 with respect to the container unit 9 (or the developing sleeve 132), and outputs a detection result signal to the control unit 76.

The control unit 76 includes a CPU (central processing unit), a RAM (random access memory), and a ROM (read only memory), or the like. The control unit 76, connected to the electromagnetic coil moving unit 5, the movable holding unit 6, the movable chuck unit 7, the electromagnetic coil 8, the inverter 49, the collection unit 10, the cooling unit 11, and the linear encoder 75 or the like to control the surface treatment machine 1 as a whole.

The control unit 76 stores a rotated magnetic field strength of the electromagnetic coil 8, which is determined based on a relative position of the electromagnetic coil 8 with respect to the developing sleeve 132, wherein such relative position of the electromagnetic coil 8 is detected by the linear encoder 75, for example. Accordingly, the control unit 76 stores power value to be applied to the electromagnetic coil 8 by the inverter 49, in which power value is determined based on a relative position of the electromagnetic coil 8 with respect to the developing sleeve 132. Further, the control unit 76 may store such power value for each type (e.g., product number) of the developing sleeve 132, for example.

In an exemplary embodiment, the control unit 76 stores a given power pattern or profile, in which a power value to be applied to the electromagnetic coil 8 from the inverter 49, is increased gradually in a longitudinal direction (or axial direction) of the developing sleeve 132 when the electromagnetic coil 8 moves over the developing sleeve 132 from the center portion toward the each end portion of the developing sleeve 132, for example. The control unit 76 controls the inverter 49 with such given power pattern or profile to change a rotated magnetic field strength generated by the electromagnetic coil 8.

As such, in an exemplary embodiment, the control unit 76 controls the inverter 49 and the electromagnetic coil 8 as above described so that a rotated magnetic field strength generated by the electromagnetic coil 8 becomes greater when to process the both end portions of the developing sleeve 132 compared to when to process the center portion of the developing sleeve 132, for example.

As above described, the control unit 76 stores a rotated magnetic field strength of the electromagnetic coil 8, which is determined based on a relative position of the electromagnetic coil 8 with respect to the developing sleeve 132, wherein such relative position of the electromagnetic coil 8 is detected by the linear encoder 75, and the control unit 76 stores corresponding power value to be applied to the electromagnetic coil 8 by the inverter 49.

Further, the control unit 76 is connected to an input unit such as, keyboard, and a display unit such as, LCD (liquid crystal display), for example.

A description is now given to a surface roughening process of the developing sleeve 132 using the surface treatment machine 1, in which the wire members 65 roughen the skin of the developing sleeve 132.

First, the control unit 76 is input with information of the developing sleeve 132 such as, product number, by using an input unit such as, touch panel. Then, the cap sleeve 64 having a cylindrical shape is engaged to the outer circumference of the developing sleeve 132 at both end portion of the developing sleeve 132.

The above-described other positioning member 54 is then engaged to the outer circumference of the hollow object holding member 32, and the hollow object holding member 32 is then inserted into the developing sleeve 132, attached with the cap sleeve 64 to its both end portion. Next, the above-described one of the positioning members 54 is also engaged to the outer circumference of the hollow object holding member 32.

In an exemplary embodiment, the developing sleeve 132 is rotatable in its circumferential direction of about its axial center when the developing sleeve 132 is not fixed to the hollow object holding member 32 by the chuck claws 40. If the chuck claws 40 may be set to a protruded condition with respect to the outer circumference face of the hollow object holding member 32, the developing sleeve 132 and the hollow object holding member 32 may be fixed by the chuck shaft 39.

At this time, the developing sleeve 132 is coaxially disposed in the hollow object holding member 32 while maintaining a given level of clearance (e.g., less than one millimeter) between the developing sleeve 132 and the hollow object holding member 32.

Then, the developing sleeve 132 and the hollow object holding member 32 are housed in the container unit 9, and the wire members 65 are supplied into the cylindrical member 50 of the container unit 9. With such process, the wire members 65 and the developing sleeve 132 are housed in the container unit 9. Further, the container unit 9 is chucked by the holding chucks 28 and 43. With such process, the developing sleeve 132 and the container unit 9 are attached to the movable holding unit 6, in which the cylindrical member 50, the hollow object holding member 32, and the developing sleeve 132 are coaxially disposed.

The movable holding unit 6 is attached to the developing sleeve 132 and the container unit 9 by adjusting a position of the moving base 26 with the above-described actuators 24 and 25, and also adjusting a position of the holding base 41. Then, the first end portion 9a of the container unit 9 is held by the fixed holding unit 4 by chucking the first end portion 9a of the container unit 9 with the holding chuck 16.

Then, gas is supplied into the container unit 9 through the gas inflow tube 66 of the collection unit 10, and the dust collector 70 sucks gas from the container unit 9. Further, the cooling unit 11 blows pressurized gas (e.g., air) to the electromagnetic coil 8.

Then the drive motor 33 is driven to rotate the hollow object holding member 3232 and the developing sleeve 132 about the axis of the developing sleeve 132.

Then, the electromagnetic coil 8 is applied with power from the three-phase alternating current source 48 to generate a rotated magnetic field having a given frequency (e.g., 200 Hz or more), for example. Then, the wire members 65, placed in an area receivable of an magnetic field effect of the electromagnetic coil 8, rotatingly move along the outer circumference of the developing sleeve 132 while rotating about the center of the wire member 65, by which the wire members 65 impact against the skin of the developing sleeve 132 to roughen the skin of the developing sleeve 132.

During such roughening process, the electromagnetic coil moving unit 5 may consecutively shift or move the electromagnetic coil 8 in the longitudinal direction of the electromagnetic coil 8 in a timely manner. With such shifting or moving of the electromagnetic coil 8, the wire members 65 newly entering an magnetic field space of the electromagnetic coil 8 starts to move (i.e., rotation about its center and rotation around the developing sleeve 132) with an effect of the above-described rotated magnetic field, and the wire members 65 getting out of the magnetic field space of the electromagnetic coil 8 stops its movement.

When the wire members 65 enter an magnetic field space of the electromagnetic coil 8, the wire members 65 may randomly and omnidirectionally impact against the surface of the developing sleeve 132, which may mean magnetic abrasive grains are impacting against the developing sleeve 132 from substantially any directions with respect to the surface of the developing sleeve 132 at a substantially same timing. Accordingly, compared to a conventional sandblasting process which may impact sand against an object from one direction at one time, the developing sleeve 132 may receive impacting stress uniformly on its surface when forming the depressions 146 by the surface processing machine 1 according to an exemplary embodiment, which may be preferable for suppressing a shape deformation of the developing sleeve 132 (e.g., misaligned axis, change of inner/outer diameter, collapsing of sleeve shape).

Further, because the partitioning members 55 partition or segment a space in the container unit 9, the wire members 65 are prevented from moving beyond each of the partitioning members 55, by which the wire members 65 getting out of the magnetic field space of the electromagnetic coil 8 also gets out from the above-described rotated magnetic field of the electromagnetic coil 8. When the electromagnetic coil moving unit 5 reciprocally moves the electromagnetic coil 8 in the direction shown by the arrow X with a given number of times, the surface roughening process for the skin of the developing sleeve 132 has completed.

In an exemplary embodiment, a rotated magnetic field strength generated by the electromagnetic coil 8 may be set to a greater value when to process the both end portions of the developing sleeve 132 compared to when to process the center portion of the developing sleeve 132, for example. In other words, a rotated magnetic field strength generated by the electromagnetic coil 8 may become gradually greater in the direction from the center portion to the both end portion of the developing sleeve 132, for example.

The greater the rotated magnetic field strength, the more vibrant the wire member 65 moves. Accordingly, as the rotated magnetic field strength increases, the wire members 65 impact against a to-be-processed object (e.g., the developing sleeve 132) with greater force, by which depth of depressions formed on the surface of the developing sleeve 132 may become gradually greater or deeper in the longitudinal (or axial) direction along the developing sleeve 132. Accordingly, depressions formed on an end portion of the developing sleeve 132 may have a greater depth compared to depressions formed on a center portion of the developing sleeve 132.

When such surface roughening process for the skin of the developing sleeve 132 has completed, a power application to the electromagnetic coil 8 is stopped, and a power application to the drive motor 33, the collection unit 10 and the cooling unit 11 is also stopped. Then, the holding chuck 16 is released from holding the container unit 9 to the fixed holding unit 4. After such releasing, the moving base 26 is departed from the fixed holding unit 4 in the direction of the arrow X by using the first actuator 24 while holding the container unit 9 with the holding chuck 43 of the movable chuck unit 7 and the holding chuck 28 of the movable holding unit 6. With such process, the container unit 9 is departed from the fixed holding unit 4. Then, the developing sleeve 132 having treated with the surface roughening process can be removed from the container unit 9. Then, another new developing sleeve is set and housed in the container unit 9 for performing another surface roughness process.

With the above-described surface roughing process, the developing sleeve 132 having a roughened skin or external surface (see FIG. 7) can be fabricated, in which depth of depressions on the developing sleeve 132 may gradually become greater or deeper in the direction from the center portion to the both end portions of the developing sleeve 132. The developing sleeve 132 according to an exemplary embodiment may have such depressions randomly formed on the developing sleeve 132 while changing depth of depressions as above described, for example. Such depth change of depressions may be provided to the developing sleeve 132 to suppress a degradation of developability at end portions of a developing sleeve, which may be caused by given factors other than developing sleeve.

Further, as illustrated in FIG. 15, with an effect of the rotated magnetic field, the wire members 65, placed in a position inside the electromagnetic coil 8, rotatingly move along the outer circumference of the developing sleeve 132 while rotating about the center of the wire member 65, by which the wire members 65 impact against the skin of the developing sleeve 132 using the outer edge 65a to roughen the skin of the developing sleeve 132.

As illustrated FIGS. 8 and 9, the skin of the developing sleeve 132 has a number of depressions 146 having elliptical shape when viewed from above the developing sleeve 132, wherein the depressions 146 are randomly formed on the skin of the developing sleeve 132. As illustrated FIGS. 8 and 9, the depressions 146 have two types of depressions, that is, first depressions 146a and second depressions 146b (see FIG. 9), wherein in the first depressions 146a, a major axis of elliptical shape may be substantially aligned in an axial direction of the developing sleeve 132, and in the second depressions 146b, a major axis of elliptical shape may be substantially aligned in a circumferential direction of the developing sleeve 132. In an exemplary embodiment, the developing sleeve 132 may have a greater number of the first depressions 146a compared to the second depressions 146b. Because the developing sleeve 132 has such greater number of depressions on its skin, the skin of the developing sleeve 132 is formed with a greater number of concavities and convexities as a whole.

In an exemplary embodiment, the magnet roller 133 employs the roller body 134 having integrated the shaft 134a at its both end portions as shown in FIG. 4, wherein the roller body 134 having the shaft 134a can be formed as one solid body or unit. Therefore, the roller body 134 can have a sufficient amount of magnetic material for generating a sufficient intensity of magnetic force, and thereby the magnet roller 133 can generate greater magnetic force even the magnet roller 133 is manufactured compact in size.

Further, because the reinforcing member 136 is embedded in the agent releasing area R of the roller body 134, the roller body 134 can enhance its stiffness, and thereby a deformation or breakage failure of the roller body 134 of the magnet roller 133 can be suppressed. With such magnet roller 133, an image forming operation can be conducted with higher precision.

Further, because the reinforcing member 136 is embedded in the roller body 134 corresponding to the agent releasing area R, the developing agent 126 used in a developing process can be released or separated from the skin or external surface of the developing sleeve 132 at the agent releasing area R.

Further, because the reinforcing member 136 is embedded in the roller body 134, a magnetic material amount used for forming the roller body 134 can be reduced compared to a roller body formed entirely with magnetic material. For example, if the roller body 134 may be made of rare earth magnetic particles, relatively high-priced material, a configuration using the reinforcing member 136 can reduce cost for manufacturing the roller body 134.

Further, because the reinforcing member 136 is made of a material having greater stiffness compared to a material used for the roller body 134, the roller body 134 having the reinforcing member 136 can enhance the stiffness of the roller body 134, and thereby a deformation or breakage failure of the roller body 134 of the magnet roller 133 can be suppressed. With such magnet roller 133, an image forming operation can be conducted with higher precision over time.

Further, because the reinforcing member 136 can be made of a magnetic material, the agent releasing area R can set to have a magnetic field which is good at releasing agent from the developing roller 115. With such magnet roller 133, an image forming apparatus can produce images having higher quality. Further, by forming the reinforcing member 136 using a lower cost material such as, resulfurized carbon steel (SUM), the magnet roller 133 can be manufactured with a reduced cost.

Further, because the reinforcing member 136 can be made of a material having higher melting temperature compared to a material for the roller body 134, the roller body 134 and the reinforcing member 136 can be integrally formed by an injection molding method (e.g., insert molding), by which a manufacturing process of the magnet roller 133 can be simplified, and the reinforcing member 136 can be fixed to the roller body 134 with higher precision. Therefore, the magnet roller 133 having higher precision can be prepared with a lower cost.

Further, by integrally forming the reinforcing member 136 and the roller body 134 by an injection molding method, a warping of the roller body 134 can be suppressed by the reinforcing member 136. Therefore, the magnet roller 133 having higher precision can be prepared with a lower cost.

Further, because the roller body 134 can be formed to have magnetic anisotropy so that magnetic force lines set parallel to one another in a cross-sectional face perpendicular to an axial direction of the roller body 134, the magnet roller 133 can generate greater magnetic force compared to a roller body that such magnetic anisotropy is not set. Because such roller body 134 can be manufactured by using the injection mold 138 having a simpler configuration, the magnet roller 133 having greater magnetic force can be manufactured with a lower cost.

Further, because the roller body 134 can be formed by an injection molding while applying a given magnetic field, the roller body 134 can be formed with a simpler manufacturing process and the roller body 134 can have a sufficient magnetic force. Therefore, the magnet roller 133 having greater magnetic force can be manufactured with a lower cost.

Because the developing roller 115 can employ such magnet roller 133, the developing roller 115 having a compact size can generate greater magnetic force, and thereby images having higher precision can be the formed by using the developing roller 115.

Further, as above described, when the depressions 146 having elliptical shape are formed on the skin of the developing sleeve 132 by impacting the wire members 65 against the skin of the developing sleeve 132 in a rotated magnetic field, the wire members 65 may impact against the surface of the developing sleeve 132 omnidirectionally, which may mean that the wire members 65 are impacting against the developing sleeve 132 from substantially any directions with respect to the surface of the developing sleeve 132 substantially at the same timing. Accordingly, compared to a conventional sandblasting process which may impact abrasive grains against an object from one direction at one time, the developing sleeve 132 may receive impacting stress uniformly on its surface when forming the depressions 146 with the surface processing machine 1 according to an exemplary embodiment, which may be preferable for suppressing a shape deformation of the developing sleeve 132 (e.g., misaligned axis, change of inner/outer diameter, collapsing of sleeve shape). Further, because the depressions 146 have a given depth, which is smaller than a V-shaped groove formed by a conventional process and deeper than depressions formed by a conventional sandblasting, an abrasion of developing agent 126 on the developing sleeve 132 can be suppressed. Accordingly, the developing roller 115 having such developing sleeve 132 can be used to produce image having higher quality with higher precision.

Further, the above-described developing roller 115 having greater magnetic force and compact size can be included in the developing unit 113, and the developing unit 113a can be included in a process cartridge, and the process cartridge can be included in an image forming apparatus, by which an image forming apparatus having a compact size can produce images with higher precision.

In an exemplary embodiment, the magnet roller 133 employs the roller body 134 having integrated with the shaft 134a at its both end portions. In other words, the roller body 134 and the shaft 134a are formed as one single solid body or unit, and thereby the roller body 134 and the shaft 134a function as one magnet as a whole. Therefore, even if the magnet roller 133 has a reduced diameter, a volume size used as magnet can be effectively attained, and thereby the magnet roller 133 having a reduced diameter can generate a greater magnetic force.

Further, because the magnet block 135, made of rare earth magnetic material, can be embedded in the groove 137 of the roller body 134, the magnet block 135 can be used as development pole of the magnet roller 133. Therefore, even if the magnet roller 133 has a reduced diameter, the magnet roller 133 can generate a greater magnetic force at the development pole.

Further, the magnet roller 133 has the second magnetic field lines J2 generated by the magnet block 135 and the first magnetic field lines J1 generated by the roller body 134 substantially perpendicular one another as shown in FIG. 6. Such magnet roller 133 have a portion D (see FIG. 6), at which the second magnetic field lines J2 and the first magnetic field lines J1 become substantially parallel one another, by which a magnetic force at the portion D of the magnet roller 133 can be set greater. With such configuration, the magnetic poles S1 and S2 (or developing agent transport poles), respectively placed at upstream and downstream of the magnet block 135 (or development pole), can set to have a greater magnetic force.

With such configured magnet roller 133 having greater magnetic force for the magnetic poles S1 and S2, magnetic carriers in the developing agent 126, transported to the development area 131, may not be attracted or adhered to the photosensitive drum 108. By suppressing magnetic carriers adhesion to the photosensitive drum 108, images having higher quality can be produced.

The aforementioned image forming apparatus 101 has the process cartridges 106Y, 106M, 106C, and 106K, wherein the process cartridges 106 includes the casing 111, the charge roller 109, the photosensitive drum 108, the cleaning blade 112, and the developing unit 113. However, the process cartridges 106 may not need to include the casing 111, the charge roller 109, the photosensitive drum 108, and the cleaning blade 112, but the process cartridges 106 may at least include the developing unit 113.

The aforementioned image forming apparatus 101 includes the process cartridges 106Y, 106M, 106C, and 106K detachably mountable in the housing 102. However, the image forming apparatus 101 may not need to include the process cartridges 106Y, 106M, 106C, and 106K, but the developing unit 113 is directly mountable in the housing 102 of the image forming apparatus 101.

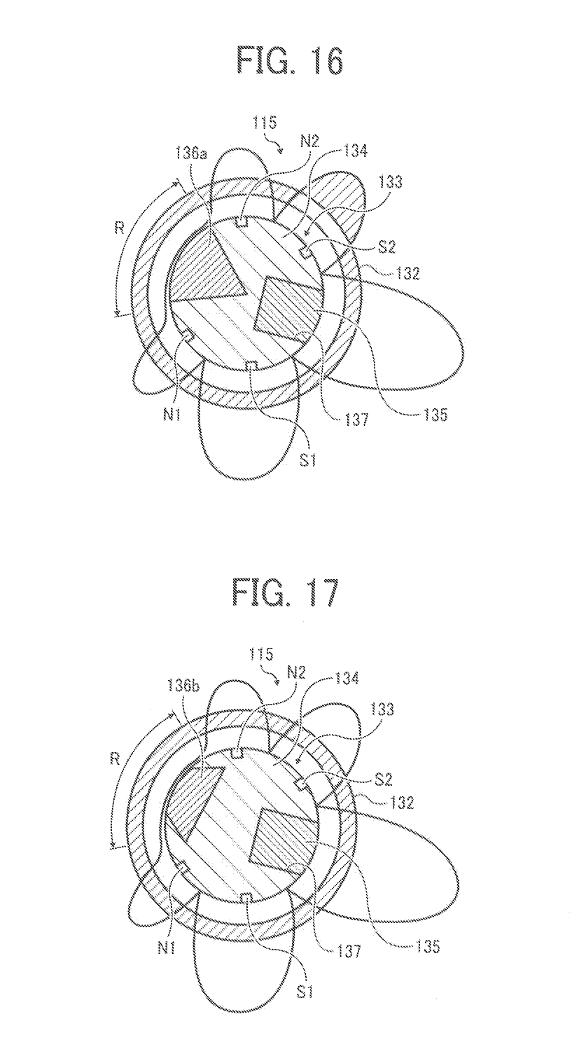

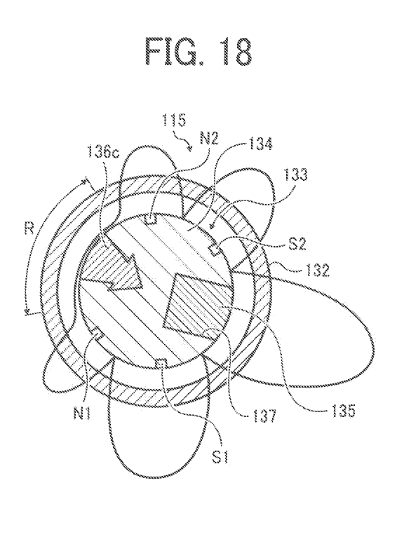

In the above-described exemplary embodiment, the reinforcing member 136 has a substantially rectangular shape in its cross-sectional face. However, as illustrated in FIGS. 16 to 18, the reinforcing member 136 can have another shape in its cross-sectional face. FIG. 16 illustrates a reinforcing member 136a having a sector form in its cross sectional shape. FIG. 17 illustrates a reinforcing member 136b having trapezoid form in its cross sectional shape, wherein a thicker part of the reinforcing member 136b is set closer to a center of the roller body 134. FIG. 18 illustrates a reinforcing member 136c having arrow shape in its cross sectional shape, wherein the arrow is directed to a center of the roller body 134.

Further, the reinforcing members 136b and 136c illustrated in FIGS. 17 and 18 can be effective for preventing a positional deviation of the reinforcing member 136 in the roller body 134, by which a disengagement of the reinforcing member 136 from the roller body 134 can be prevented. Further, if the reinforcing members 136b and 136c illustrated in FIGS. 17 and 18 are formed integrally with the roller body 134 by an injection molding or the like, a warping of the roller body during a cooling process of the roller body 134 can be effectively suppressed.

A description is now given to experiment results of the magnet roller 133 using Comparison Examples and Examples 1 and 2, manufactured with a process according to an exemplary embodiment.

### Comparison Example

A plastic magnet (TP-S68, product of TODA KOGYO CORP.), which is a mixture of magnetic particles of strontium ferrite powder having magnetic anisotropy and polymer compound of 6 nylon, was injected in a metal mold while keeping a temperature of 300 degrees Celcius and applying a magnetic field of 0.7 T to form the roller body 134 having a diameter of 8.5 mm and a length of 313 mm, and having the groove 137 having a width of 3 mm and a depth of 2.3 mm on the roller body 134. Then, the magnet block 135, prepared separately, was fixed in the groove 137. In this Comparison Example, the reinforcing member 136 was not provided.

The magnet block 135 was made of a rare earth magnet having magnetic anisotropy. Specifically, 950 g of Ne—Fe—B rare earth magnet (MFP-13, product of AICHI STEEL CORPORATION) was mixed with 50 g of thermoplastic resin with a mixer with a mixing condition of 22 rpm (rotation per minute) for 10 minutes. The thermoplastic resin includes a polyester resin of 100 weight part, quaternary ammonium salt (used as charge control agent) of 1.5 weight part, styrene-acrylic resin (material for lower softening point) of 1.5 weight part, carbon black of 2.0 weight part, and silica (H2000) of 1.5 weight part. The mixed materials of 12.0 g was injected to a cavity (having a width of 2.2 mm, a height of 10.0 mm, a length of 313 mm) of a metallic mold made of magnetic material (SKS3), and an magnetic field orientation current of 100 A was flowed in a direction perpendicular to a pressing direction using 400 kN as pressing force. Then, the metallic mold and the magnet block 135 were de-magnetized using a pulse voltage of 3500V, and the magnet block 135 was removed from the metallic mold. The magnet block 135 was baked at a temperature of 100 degrees Celcius for 60 minutes. The resultant magnet block 135 had a width of 2.8 mm, a height of 2.2 mm, and a length of 313 mm.

### Example 1

As similar to Comparison Example, the roller body 134 was prepared, and the roller body 134 was provided with a groove corresponding to the agent releasing area R. The groove had a width of 3.9 mm and a depth of 2.1 mm. As similar to Comparison Example, the magnet block 135 was provided in the groove 137 of the roller body 134, corresponding to the development pole, and the reinforcing member 136, made of aluminum base alloy and having a width of 3.8 mm, a height of 2 mm, and a length of 313 mm was disposed at the groove of the roller body 134, corresponding to the agent releasing area R.

### Example 2

As similar to Example 1, the roller body 134 was prepared and the magnet block 135 was provided in the groove 137 of the roller body 134, and the reinforcing member 136, made of resulfurized carbon steel (SUM) and having same size used in Example 1 was disposed at the groove of the roller body 134, corresponding to the agent releasing area R.

Each of the magnet rollers 133 prepared by Comparison Example, Examples 1 and 2 was tested as below. While supporting both end of the magnet roller 133, a load of 100 g was applied to a center of the magnet roller 133, and a shape deformation of the magnet roller 133 was measured with a dial gauge to measure stiffness of the magnet roller 133. Based on the experiment, the magnet roller 133 of Example 1 had a stiffness greater than the magnet roller 133 of Comparison Example by about 1.5 times, and the magnet roller 133 of Example 2 had a stiffness greater than the magnet roller 133 of Comparison Example by about 2.5 times. Accordingly, the magnet roller 133 can enhance its stiffness by disposing the reinforcing member 136.

Further, each of the magnet rollers 133 prepared by Comparison Example, Examples 1 and 2 was magnetized by an electromagnet to obtain a magnetic property shown in FIG. 5. In Comparison Example, a magnetic pole disposed near the agent releasing area R had a magnetic pole opposite to the magnetic poles N1 and N2, wherein magnetic poles N1 and N2 are adjacent to the agent releasing area R. In Examples 1 and 2, a magnetic pole disposed to the agent releasing area R had a magnetic pole same as the magnetic poles N1 and N2, wherein magnetic poles N1 and N2 are adjacent to the agent releasing area R, by which a magnetic field for effectively releasing the developing agent 126 was formed in Examples 1 and 2.

Further, each of the magnet rollers 133 prepared by Comparison Example, Examples 1 and 2 was inserted in the developing sleeve 132 made of aluminum base alloy to check agent releasing property from a skin or external surface of the developing sleeve 132. In Comparison Example, a tiny amount of the developing agent 126 was still attracted at the agent releasing area R of the developing sleeve 132, but in Examples 1 and 2, the developing agent 126 was not attracted at the agent releasing area R of the developing sleeve 132.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims. For example, position of magnetic poles, N or S pole of magnetic poles can be changed within the scope of the appended claims.

What is claimed is:

1. A magnet roller for use with a hollow cylindrical structure made of a non-magnetic material, the magnet roller comprising:
a roller body, encased in the hollow cylindrical structure, configured to have at least one magnetic pole to form an agent releasing area on a skin of the cylindrical structure, the roller body being integrated with a shaft on each end portion of the roller body as one solid body; and
a reinforcing member embedded in a portion of the roller body corresponding to the agent releasing area,
the reinforcing member being made of a material different from a material used for the roller body,
the reinforcing member extending in an axial direction of the roller body.

2. The magnet roller according to claim 1, wherein the material used for the reinforcing member has a rigidity greater than the material used for the roller body.

3. The magnet roller according to claim 1, wherein the material used for the reinforcing member is a magnetic material.

4. The magnet roller according to claim 1, wherein the material used for the reinforcing member has a melting temperature higher than a melting temperature of the material used for the roller body.

5. The magnet roller according to claim 1, wherein the reinforcing member and the roller body form a single integrated unit.

6. The magnet roller according to claim 1, wherein the roller body has magnetic anisotropy, setting magnetic force lines in parallel in a cross-sectional face with respect to an axial direction of the roller body.

7. The magnet roller according to claim 1, wherein the roller body is made of a mixed material including magnetic particles and polymer compound,
the mixed materials being injected into a cavity of a metallic mold given with a predetermined magnetic field orientation.

8. An image forming apparatus, comprising:
a developing sleeve having a hollow cylindrical structure made of a non-magnetic material; and
a magnet roller,
the magnetic roller including:
a roller body, encased in the hollow cylindrical structure, configured to have at least one magnetic pole to form an agent releasing area on a skin of the cylindrical structure, the roller body being integrated with a shaft on each end portion of the roller body as one solid body; and
a reinforcing member embedded in a portion of the roller body corresponding to the agent releasing area,
the reinforcing member being made of a material different from a material used for the roller body,
the reinforcing member extending in an axial direction of the roller body.

9. The image forming apparatus according to claim 8, wherein the developing sleeve and the magnet roller are integrated as a developing agent carrier.

10. The image forming apparatus according to claim 9, wherein the developing sleeve has a skin having a number of concavities and convexities formed therein by impacting wire members against the skin omnidirectionally using a rotated magnetic field.

11. The image forming apparatus according to claim 9, further comprising a developing unit including the developing agent carrier.

12. The image forming apparatus according to claim 11, further comprising a process cartridge including the developing unit,
wherein the process cartridge is detachably mountable in the image forming apparatus.
